(19) United States
(12) Patent Application Publication
(10) Pub. No.: US 2003/0106899 A1
(43) Pub. Date: Jun. 12, 2003

(54) Container for microwave popcorn and method and apparatus for making the same

(76) Inventor: H. J. Paul Langen, Brampton (CA)

Correspondence Address: Arnold B. Silverman, Esquire, Eckert Seamans Cherin & Mellott, LLC, 44th Floor, 600 Grant Street, Pittsburgh, PA, 15219, US

(21) Appl. No.: 10/317,618

(22) Filed: Dec. 12, 2002

Related U.S. Application Data
(60) Provisional application No. 60/339,631, filed on Dec. 12, 2001.

(51) Int. Cl. A23L 1/18

(52) U.S. Cl. 220/912; 99/323.5

(57) ABSTRACT

A container for use in making popcorn in a microwave oven has an outer enclosure enclosing an outer cavity. The outer enclosure is preferably made from a rigid or semi-rigid microwave transparent material. An inner enclosure is enclosed within the outer cavity. A susceptor is provided for absorbing microwave radiation to heat popcorn kernels. The inner enclosure will release a plurality of un-popped popcorn kernels and a charge enclosed in the inner enclosure when the container is subjected to a heat source such as microwave radiation. The outer enclosure is movable, by application of external forces to the outer enclosure, from a first configuration to a second erected configuration and the outer cavity has increased in size so as to accommodate popped kernels released from the inner enclosure.

### RELATED APPLICATIONS

This application is related to and claims the benefit of U.S. Provisional Patent Application Serial No. 60/339,631, filed Dec. 12, 2001, the contents of which are hereby incorporated herein by reference.

### BACKGROUND OF THE INVENTION

The present invention relates to containers for storing and cooking microwave popcorn products.

For at least two decades, parties involved in the food industry have been making various types of containers that can be used for storing food items. The same containers can also be used for heating the food items by placing the container with the food items contained therein in a microwave oven and subjecting the container to microwave radiation. One particular sector of the food industry that has been very active in employing such containers is the microwave popcorn industry. In this food industry sector, the containers have taken several different forms.

To ensure a commercially successful microwave popcorn product there are several design considerations for microwave popcorn containers. For example, the containers holding the microwave popcorn should be attractive to consumers in both their delivered/stored configuration and also after the corn has been popped in the container in the microwave oven. The container must also keep the kernels and charge (such as oil) fresh during storage, yet provide adequate, reliable and controlled venting to control pressure buildup when the popcorn is heated in the microwave oven. The container should also have a relatively easy opening mechanism. Yet having regard to the container design criteria, the container should also be capable of being manufactured using a relatively simple and inexpensive manufacturing process and employ relatively inexpensive materials.

There are different approaches to providing microwave popcorn containers. One of the most common forms of container is a flexible, expandable microwave popcorn bag. These bags are usually made from a paper product in combination with other elements. The bags hold popcorn kernels, and usually a popcorn charge or slurry comprising for example, a cooking oil and possibly seasonings/flavorings. The bags having been delivered in a flattened and folded configuration to the consumer are unfolded by the consumer and then placed into a microwave oven where they are subjected to microwave radiation. The kernels are heated, which creates steam inside the kernels as the water evaporates. This creation of steam causes the kernels to pop thereby creating popcorn. The release of steam from the kernels into the interior of the bag by the popping action causes the pressure inside the bag to increase, which in turn causes the bag to expand, allowing room for additional kernels to be popped.

Microwave popcorn bags have several benefits, including being made from relatively inexpensive materials and also being able to be delivered to the consumer in a relatively small, compact container.

However, bags have several drawbacks including that once filled with popcorn, they are somewhat physically unstable, as they do not have a solid base upon which to rest. Although bags are fine for consuming popcorn if held, it is often not desirable to continue holding a bag. Accordingly, consumers often empty the bag into another readily available container such as a glass bowl, creating a container that must thereafter be cleaned.

Moreover there are several design considerations that make the construction of a suitable flexible bag quite difficult. For example, the material from which the bag is made must be stable enough to withstand the heat generated by the susceptor which is typically used for heat generation, but on the other hand it must be flexible enough to permit proper expansion. Additionally, although the increase in internal pressure is required to inflate the bag from its flattened configuration, appropriate venting of the bag during the cooking process is required to limit the internal pressure so as to avoid rupture and accompanying spillage.

A variation of the flexible paper bag is disclosed in U.S. Pat. No. 5,171,950 issued Dec. 15, 1992 to Brauner et al. This patent discloses a self-opening flexible pouch which contains the popcorn and charge. The pouch was intended to be marketed to consumers in a paper bag so that when the kernels in the pouch are heated the pouch will release the popcorn into the outer bag.

In contrast to using flexible, expandable bags, another approach that is known is the use of containers made from more rigid materials such as cardboard. The materials from which these containers are made have generally been such that internal pressure is not used to create the receptacle for holding the popped kernels. Rather these containers are delivered to the consumer in a form that generally provides the cavity for the popcorn. By way of example, U.S. Pat. No. 6,126,976 issued Oct. 3, 2000 to Hasse, Jr. et al discloses a tub shaped container having cone-shaped, tapered side walls. The tubs can be stacked one inside another for shipping purposes. This patent also teaches the use of a sealed pouch to contain the popcorn and kernels and a lid for the tub. However, the container disclosed in Hasse Jr. et al. is relatively difficult and expensive to construct and assemble and provides a relatively bulky container for shipping and delivery to the consumer.

### SUMMARY OF INVENTION

In one aspect of the invention there is provided a container for use in making popcorn in a microwave oven, said container comprising:

a) An outer enclosure enclosing an outer cavity, said outer enclosure made from a rigid or semi-rigid microwave transparent material;

b) An inner enclosure enclosed within said outer cavity and enclosing an inner cavity, said inner enclosure including a base portion with a susceptor for absorbing microwave radiation to heat popcorn kernels located in the vicinity of said susceptor, said inner enclosure having an opening sealed by a seal;

c) a plurality of un-popped popcorn kernels and a charge enclosed in said inner cavity, wherein at least some of said plurality of kernels will pop and expand when said container is subjected to microwave radiation, and wherein the pressure in said inner cavity will increase and said seal will be released to release said popped kernels from said inner enclosure within said outer cavity;

said outer enclosure and said inner enclosure being adapted such that said outer enclosure is movable, by application of external forces to said outer enclosure, from a first configuration wherein said outer enclosure and said inner enclosure are in a generally flattened configuration to a second configuration wherein said outer enclosure is in an erected configuration and said outer cavity has increased in size so as to accommodate said popped kernels released from said inner cavity.

In yet another aspect of the invention there is provided a container for use in making popcorn in a microwave oven, said container comprising:

a) a self erecting container made from a microwave transmissible material and having an expandable internal cavity, said container being movable from a first generally flattened configuration to a second erected configuration, whereby the size of said cavity is increased;

b) an inner pouch containing a plurality of popcorn kernels and an associated charge, said pouch having a susceptor for absorbing microwave radiation to heat said kernels, and said pouch being located within said expandable cavity, wherein at least some of said plurality of kernels will pop and be released by said pouch within said cavity, when said container is subjected to microwave radiation.

In still yet another aspect of the invention, there is provided a method of forming a pouch for use in a microwave popcorn container from a longitudinally extending web, said web comprising:

a) A longitudinally extending base layer, said base layer having a longitudinally extending medial folding line;

b) A susceptor material bonded to and stretching along one half of a first side of said base layer;

c) A first strip of heat activated adhesive located on said opposite side to said first side, and extending longitudinally, proximate an upper edge on said opposite side of said base layer;

d) A series of transversely extending strips of heat activated adhesive located on said opposite side, said strips extending from a lower edge located opposite to said upper edge, to a position past said folding line;

said method comprising the steps of:

i. moving said web longitudinally

ii. folding said web about said medial folding line such that said upper portion of said opposite surface faces said lower portion of said opposite surface

iii. activating said heat adhesive to bond said lower portion to said upper portion along said transverse strips of adhesive to form a plurality of pockets closed along a bottom and both opposite side of said pockets

iv. moving said pockets horizontally with the open side of each of said plurality of pockets generally oriented upwards

v. filling each of said pockets with a plurality of un-popped popcorn kernels and a charge

vi. sealing the upper side of said pocket vii. transversely cutting each of said pockets through at a medial position along said side seals to cut a plurality of sealed pouches from said web.

In another aspect of the invention, there is provided a method of forming a pouch for use in a microwave popcorn container from a longitudinally extending web, said web comprising:

a) A longitudinally extending base layer, said base layer having a longitudinally extending medial folding axis and a first side and a second opposite side;

b) A susceptor material secured to at least a portion of said first side said base layer;

said method comprising the steps of:

i. moving said web substantially horizontally;

ii. folding said web transversely about said longitudinally extending medial axis such that an upper portion of said opposite surface faces a lower portion of said opposite surface

iii. bonding said lower portion at discrete locations to form a plurality of pockets, said pockets being closed along a bottom edge and along opposite side edges of said pockets, and having an upwardly directed opening;

iv. moving said pockets horizontally to a filling station and filling each of said pockets through said opening with un-popped popcorn kernels and a charge;

v. sealing the opening of said pocket

vi. transversely cutting said web at a side edge of each of said pockets to cut a plurality of sealed pouches from said web.

In still yet another aspect of the invention, there is provided a web for use in forming a pouch to hold popcorn kernels, said web comprising:

a) A longitudinally extending base layer, said layer having a longitudinally extending medial line;

b) A susceptor material bonded to and stretching along one half of a first side of said base layer;

c) A first strip of heat activated adhesive located on said opposite side to said first side, and extending longitudinally, proximate an upper edge on said opposite side of said base layer;

d) A series of transversely extending strips of heat activated adhesive located on said opposite side, said strips extending from a lower edge located opposite to said upper edge, to a position past said medial line.

In still yet another aspect of the invention, there is provided a web for use in forming a pouch to hold popcorn kernels, said web comprising:

a) A longitudinally extending base layer having a first and second side, said layer having a longitudinally extending medial line and being made from a foldable material;

b) A susceptor material stretching along one half of said first side of said base layer;

c) A continuous strip of heat activated adhesive located on said second side which is opposite to said first side, and extending from a first position on said medial line, toward an upper edge of said web and thereafter to a second position on said medial line.

In another aspect of the invention there is provided a pouch comprising:

a) A longitudinally extending base layer having a first outer side and a second inner side, said layer having a longitudinally extending medial fold line and being made from a foldable material;

b) A susceptor material positioned on a portion of said first side of said base layer;

c) A continuous strip of heat activated adhesive located on said second inner side which is opposite to said first side, and extending from a first position on said medial line, toward an upper edge of said web and thereafter to a second position on said medial line, said strip of adhesive bonding a first portion of said inner side to a second portion of said inner side to provide a cavity having a boundary defined by said medial fold line and said strip of adhesive;

d) A plurality of kernels and a charge contained within said cavity; wherein said adhesive strip will release popcorn formed within said cavity, when said pouch is subjected to microwave radiation.

In yet another aspect of the invention, there is provided a method of forming a container for use in creating popcorn in a microwave oven, said container comprising an outer enclosure made from a blank and enclosing therein a pouch, said container being adapted to be movable with said pouch enclosed therein from a first substantially flattened configuration to a second erected configuration, said method comprising:

a) moving a longitudinally extending web of blanks to a pouch placement station, each blank having a plurality of panels;

b) placing a releasable pouch containing a plurality of popcorn kernels and a charge, on one of said plurality of panels

c) folding and securing said panels to enclose each said pouch within a cavity formed within said blank.

In another aspect of the invention, there is provided a container for use in making popcorn in a microwave oven, said container comprising:

a) A rigid or semi rigid-outer housing made from a microwave transmissible material, said housing defining and enclosing an internal cavity; said housing having a tab portion protruding therefrom which is suitable for holding said container;

b) a plurality of popcorn kernels and an associated charge in said cavity,

c) a susceptor for absorbing microwave radiation to heat said kernels, wherein at least some of said plurality of kernels will pop and be released by said pouch within said cavity, when said container is subjected to microwave radiation.

In yet another aspect of the invention there is provided a container for making popcorn in a microwave open, comprising:

a) an outer enclosure having a first, low volume configuration and a second high volume configuration;

b) a pouch within said outer enclosure, said pouch containing popcorn kernels.

In still yet another aspect of the invention, there is provided a container for use in making popcorn in a microwave oven, said container comprising:

a) An outer enclosure defining an outer cavity, said outer enclosure made from a rigid or semi-rigid microwave transparent material;

b) An inner enclosure enclosed within said outer cavity and defining an inner cavity, said inner enclosure having a sealed opening;

c) a susceptor for absorbing microwave radiation to heat popcorn kernels located in the inner enclosure;

d) a plurality of un-popped popcorn kernels and a charge enclosed in said inner cavity, wherein at least some of said plurality of kernels will pop and expand when said container is subjected to microwave radiation, and wherein the pressure in said inner cavity will increase a seal at said sealed opening will be released to release said popped kernels from said inner enclosure to said outer cavity;

said outer enclosure and said inner enclosure being adapted such that said outer enclosure is movable, by application of external forces to said outer enclosure, from a first configuration wherein said outer enclosure and said inner enclosure are in a generally flattened configuration to a second configuration wherein said outer enclosure is in an erected configuration and said outer cavity has increased in size so as to accommodate said popped kernels released from said inner cavity.

In another aspect of the invention, there is provided a container for use in making popcorn in a microwave oven, said container comprising:

a) a self erecting outer enclosure having an internal cavity, said outer enclosure being movable from a first configuration to a second erected configuration, whereby the volume of said internal cavity is increased in said second erected configuration;

b) an inner enclosure containing a plurality of un-popped popcorn kernels and said inner enclosure being located within said expandable internal cavity, said pouch inner enclosure being arranged for releasing popping kernels into said internal cavity, when said container is subjected to a source of heat.

In yet another aspect of the invention there is provided a method of forming a container for use in making popcorn in a microwave oven, said container comprising an outer enclosure made from a blank and enclosing therein a cavity, said cavity having therein an inner enclosure, said container having a susceptor and said container being adapted to be movable with said susceptor and said inner enclosure enclosed therein from a first configuration to a second erected configuration thereby increasing the volume of said cavity, said method comprising:

a) moving a blank to a pouch placement station, said blank having a plurality of panels, including a base panel;

b) at said pouch placement station, placing a releasable pouch containing a plurality of un-popped popcorn kernels and a charge, on said base panel;

c) folding and securing said panels to enclose said pouch within said cavity formed within said blank, to form a container capable of being moved from said first configuration to said second configuration.

In still yet another aspect of the invention, there is provided an apparatus for forming a container for use in making popcorn in a microwave oven, said container comprising an outer enclosure made from a blank and enclosing therein a cavity, said cavity having therein a pouch, said container having a susceptor and said container being adapted to be movable with said susceptor and said inner enclosure enclosed therein from a first configuration to a second erected configuration thereby increasing the volume of said cavity, said apparatus comprising:

a) A magazine holding a plurality of blanks, each of said blanks having a plurality of panels, including a base panel;

b) A conveyor system for moving a blank from said blank magazine to a pouch placement station, and from said pouch placement station to folding and securing stations,

c) A pouch feeder positioned at said pouch placement station for placing a pouch containing a plurality of un-popped popcorn kernels on one of said base panel;

d) A folding and securing station operable to fold said panels to enclose said pouch within said cavity formed within said blank, so as to form a container capable of being moved from said first configuration to said second configuration.

In another aspect of the invention, there is provided a container for use in heating food products comprising:

a) an outer enclosure enclosing a cavity, said outer enclosure made from a rigid or semi-rigid microwave transparent material, said enclosure being formed from a plurality of interconnected panels, said plurality of panels including a plurality of medial panels including a base panel, and a plurality of upstanding side wall panels;

b) a gap between a first side wall panel and a second side wall panel of said plurality of side wall panels, said first and second side wall panels being positioned adjacent to each other and each interconnected to a medial panel,

c) a barrier positioned across said gap and extending between said first side wall panel and said second side wall panel and said base panel, said adapted to block said gap in the vicinity of said base panel to substantially prevent seepage through said gap of fluid held in said cavity.

Other features and advantages will be evident from the following description and drawings relating to preferred embodiments of the invention.

### BRIEF DESCRIPTION OF THE DRAWINGS

In drawings illustrating by way of examples only, embodiments of the invention:

FIG. 1 is a perspective view of a first embodiment of a container constructed in accordance with the invention;

FIG. 2 is a cross section at 2-2 in FIG. 3

FIG. 3 is a plan view of part of a web used to make part of the container of FIG. 1;

FIG. 3a is a plan view of part of an alternate web that can be used to make a part of the container in accordance with the invention;

FIG. 3b is a plan view of part of another alternate web that can be used to make a part of the container in accordance with another embodiment of the invention;

FIG. 4 is a roll of the web material of FIG. 3;

FIG. 5 is a schematic view of an example process for making part of the container of FIG. 1;

FIG. 6 is a plan view of the part of the container of FIG. 1 made by the process of FIG. 5;

FIG. 6a is a plan view of an alternate part to the part in FIG. 6, of the container of FIG. 1;

FIG. 6b is a plan view of an alternate part to the part used in FIGS. 6 and 6a, of the container of FIG. 1;

FIGS. 7 and 8 are front views showing the container of FIG. 1 in use in a microwave oven;

FIG. 9 is a perspective view of the part of FIG. 6, shown in its closed configuration;

FIG. 9a is a perspective view of the part of FIG. 6a, shown in its closed configuration;

FIG. 10 is another perspective view of the part of FIG. 6, shown in its opened configuration;

FIG. 10a is another perspective view of the alternate part of FIG. 6a, shown in its opened configuration;

FIG. 11 is a perspective view of the container of FIG. 1 in use;

FIG. 12 is also a perspective view of the container of FIG. 1 in use;

FIGS. 13 to 18 are schematic views illustrating a method of forming the container of FIG. 1;

FIGS. 19 to 21 comprises a side and perspective views of the container of FIG. 1, showing the erection operation;

FIG. 22 is a plan view of an alternate part for use in forming a container in accordance with another embodiment of the invention;

FIG. 23 is a plan view of an alternate part for use in forming a container in accordance with another embodiment of the invention;

FIGS. 24 to 30 are schematic views illustrating a method of forming another container using the part illustrated in FIG. 23;

FIGS. 31 to 33 comprises a side and perspective views of a container formed in the method of FIGS. 24 to 30, showing the erection operation;

FIG. 33a is a perspective view of the container of FIGS. 31 to 33, illustrating the inner pouch in an opened configuration.

FIG. 34 is a schematic side view of part of an apparatus used in the method of FIGS. 24 to 30 to form a container in accordance with an embodiment of the invention;

FIG. 35 is a cross sectional view taken at 35-35 in FIG. 34 to illustrate in detail a pouch placement apparatus that can be used in the apparatus of FIG. 34;

FIG. 36 is a detailed side elevation view of a device comprising the apparatus of FIG. 34;

FIG. 37 is a detailed side view of part of the device of FIG. 36;

FIG. 38 is a top view at 38-38 in FIG. 37;

FIG. 39 is a schematic view showing the trajectory of the pick up head forming part of the device of FIG. 36;

FIG. 40 is a flow chart showing a method of carrying on a business of delivering microwave popcorn to a consumer for consumption.

### DETAILED DESCRIPTION

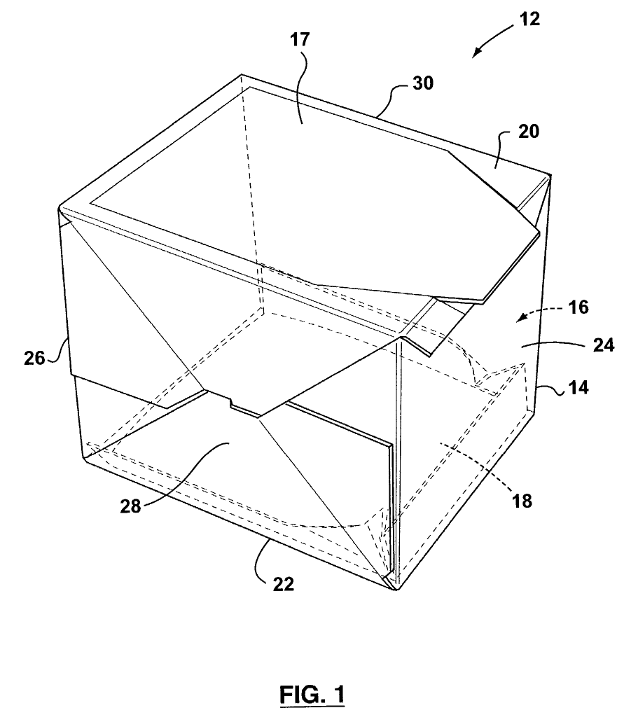

With reference to FIG. 1, a container 12 for use in making microwave popcorn is shown. Container 12 comprises two basic components: an outer enclosure 14 and inner enclosure 18. In this embodiment outer enclosure 14 consists of a housing in form of a self-erecting cardboard box. The outer enclosure 14 encloses an internal cavity 16 in which is located an inner enclosure 18 which in this embodiment is in the form of a generally flexible pouch.

Outer enclosure 14 has a top panel 20 with a removable lid portion 17, a bottom panel 22, a first solid front wall 24 and second solid rear wall 26. Completing the rectangular box are identical side walls 28 and 30, which are comprised of a plurality of individual overlapping panels which have an interlocking feature, which provide for an interference fit connection. The panels form opposed side walls 28 and 30 and complete the box and partially define the internal cavity 16, when the box is in its erect configuration shown in FIG. 1. Although a specific rectangular parallelepiped configuration for outer enclosure 14 is disclosed herein, other configurations and shapes could be employed.

For example, containers disclosed in U.S. Pat. No. 3,494,536 issued to Henry on Feb. 10, 1970, U.S. Pat. No. 4,291,828 issued Sep. 29, 1981 to Nigro, and U.S. Pat. No. 6,155,479 issued Dec. 5, 2000 to Wellner et al, could be readily utilized or easily modified to fulfill the requirements of the present invention and the contents of those documents are hereby incorporated herein by reference.

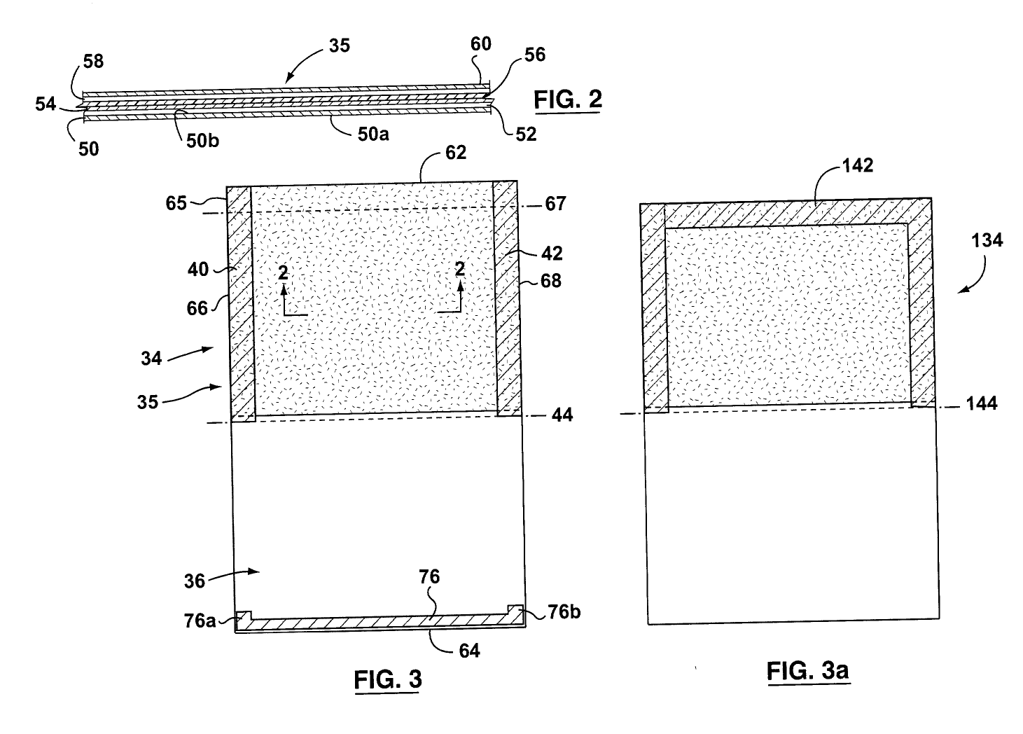

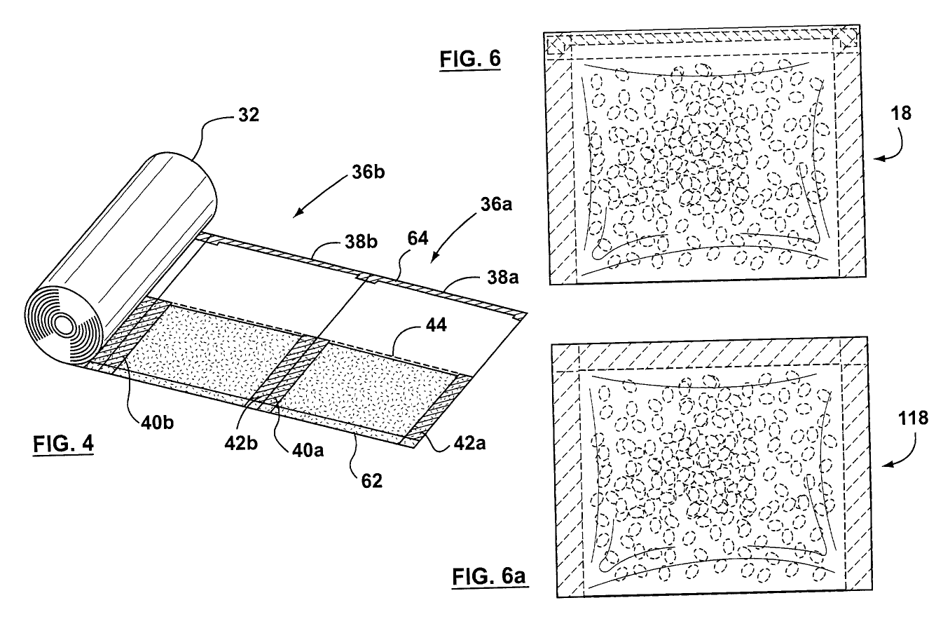

With reference to FIGS. 2 to 4 the components of the inner enclosure 18 are illustrated in detail. In FIG. 4, a web 34 is provided in a roll 32. Web 34 is divided into a series of longitudinally arranged web portions 36 (such as portions 36a and 36b illustrated in FIG. 4). As clearly shown in FIG. 4, each web portion 36a, 36b comprises a longitudinally extending upper adhesive strip 38a, 38b respectively, as well as a pair of longitudinally spaced, transversely extending side strips of adhesive 40a, 42a and 40b, 42b which extend from a side edge 62 transversely to (and may extend just past) a medial longitudinally extending folding line 44 in web 34.

In FIG. 2 the different layers of materials that may form a preferred web 34 are depicted. Base layer 50 is a layer of greaseproof paper and can be 20 to 25 pound kraft paper having grease resistant properties. Other materials would be suitable for base layer 50, but they are should be grease proof, and should be capable of being constructed into a pouch or other type of inner enclosure 18 which is self-releasable (ie. when internal pressure is exerted within the pouch, an opening can be formed in the inner enclosure to release the popcorn into volume of the internal cavity contained by the outer housing 14).

The surface 50a of layer 50 is the innermost layer when pouch 18 is formed and is in direct contact with the microwave popcorn kernels and the charge contained in pouch 18 formed from web 34. Laminated or otherwise bonded to the opposite surface 50b of layer 50 by a suitable heat resistant adhesive from HB Fuller Inc. such as model no WC3460ZZ. Layer 52 is a layer of a suitable polyester such as polyethylene tetrephthalate (PET) 56 having deposited on its inner surface a suitable susceptor material 54 which is typically some kind of metallic material such as aluminum. The susceptor material 54 is deposited in known ways such as by vacuum deposition. An example of a suitable combination of a suitable polyester and metal susceptor layer is manufactured by A.D. Tech under designation PC 48G PTC AL—item no. P120 CA 01270 NBKZ. Thus, the susceptor material 54 is sandwiched between paper layer 50 and polyester layer 56.

In this embodiment an additional outer layer of paper 60 is bonded to the PET layer 56 with a heat resistant glue layer 58 from [which also may be model no WC3460ZZ from HB Fuller Inc.] to give even greater thermal stability to web 34.

Paper layer 60 can, for example, be a clay coated paper. However, it should be noted that it may not, in some embodiments, be necessary to provide an additional layer of paper 60 or other similar material. Indeed, the general criteria for web 34 are that it should provide a base layer that provides grease resistance and a suitable susceptor that may be on or above the base layer. The base layer 50 should have sufficient thermal stability when the susceptor is heated by the microwave radiation, otherwise the pouch material can disintegrate and become mixed with the popcorn. The susceptor may be carried on a separate layer of material, such as a suitable polyester as described above, so the susceptor material is sandwiched between the paper 50 and the polyester 56 layers, however other types of susceptors can be utilized.

The materials described above provide for an inner pouch that is sufficiently microwave transmissible such that an appropriate amount of heat can be developed in the susceptor to cause the corn kernels that are held in pouch 18 to be transformed into popcorn.

In other embodiments, the susceptor could be provided in a separate layer sandwiched between the layer 60 of the inner enclosure 18 and inner surface of base panel 22 of the outer enclosure 14. The susceptor could also be formed with the base panel, such as for example being integrally formed therewith. Various types of known susceptors can be employed. The important factor is that sufficient heat be generated to appropriately heat the popcorn kernels and charge that are held in inner enclosure 18.

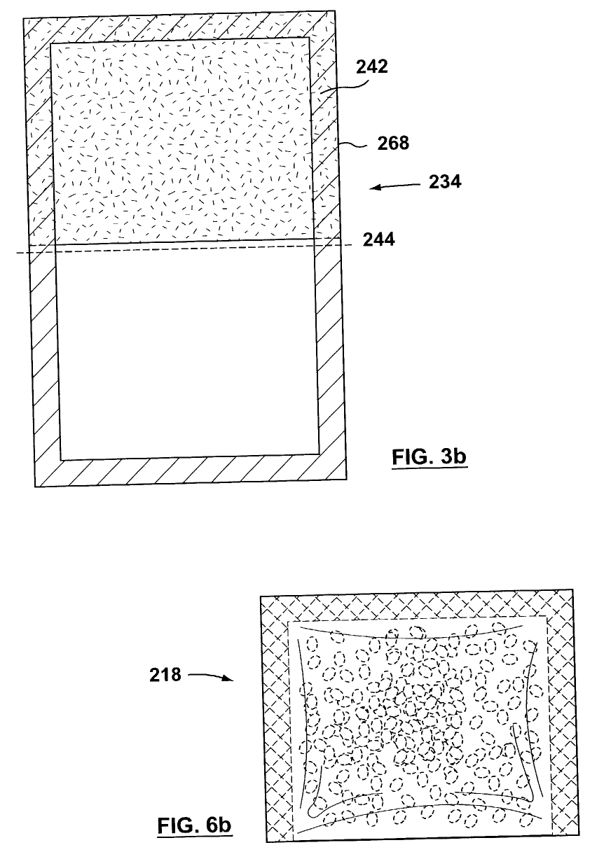

With reference now to FIG. 3, the susceptor material 54 and the accompanying layer of polyester 56 may be present only on the upper portion 35 of the web and not lower portion 36. Upper and lower portions 35, 36 are divided along medial fold line 44.

Extending from upper edge 62 along each side edge 66 and 68, to medial fold line 44 are strips of heat activated adhesive 40 and 42. Extending longitudinally along lower edge 64 is a longitudinally extending strip of heat activated adhesive 76 having end sections 76a, 76b. Although not clearly depicted as such in FIGS. 3 and 6, sections 76a and 76b of the adhesive may extend far enough to ensure a complete seal all around the perimeter.

A secondary fold line 67 is provided proximate to, and spaced from upper edge 62. Secondary fold line 67 provides for a tab 65 which is folded downwards during formation of the pouch 18, and folded tab 65 is adhered to pouch portion 36 with adhesive strips 76, 76a, 76b. The adhesive strips are generally provided on the inner surface 50a of the web and can be any suitable heat activated adhesive such as a hot melt adhesive, like the 1HL 9918x extrudable hot melt manufactured by HB Fuller Inc. (another possible glue is model PWF3000 by HB Fuller Inc.) Hot melt adhesives will soften and become tacky when heated. This allows a bond to be made between two bodies (ie. two parts of the web) with the adhesive when the adhesive is heated and allowed thereafter to cool. However, as the adhesive loses most of its strength when heated, heating the adhesive again, will also allow two bodies (ie. two parts of the web) bonded by the adhesive to be separated when a force is applied to separate the two bodies.

The susceptor material may extend close to the upper edges 62, to assist in activating the heat activated adhesive. However, sufficient heat may otherwise be generated in the pouch 18 such that the heat activated adhesive does not have to be directly above the susceptor material in order to release the popcorn as described below.

In FIG. 3a, a portion of an alternate form of web 134 is shown. This web is formed with one continuous generally C-shaped strip of heat activated adhesive 142 on the inner surface. It also only has only one fold line, medial fold line 144. When folded about fold line 144, a pouch having an inner cavity, which is completely sealed, can be formed by activating the adhesive and bonding to an opposite surface area. The boundaries of the inner cavity are defined by the C-shaped adhesive and the web material at the fold line 144.

In FIG. 3b, a portion of yet another alternate form of web 234 is shown.

This web is formed with one continuous generally rectangular-shaped strip of heat activated adhesive 242 on the inner surface. It also only has only one fold line, medial fold line 244. When folded about fold line 244, a pouch having an inner cavity, which is completely sealed, can be formed by activating the adhesive and bonding to an opposite surface area. The boundaries of the inner cavity are defined by the rectangular-shaped adhesive strip and the web material at the fold line 244.

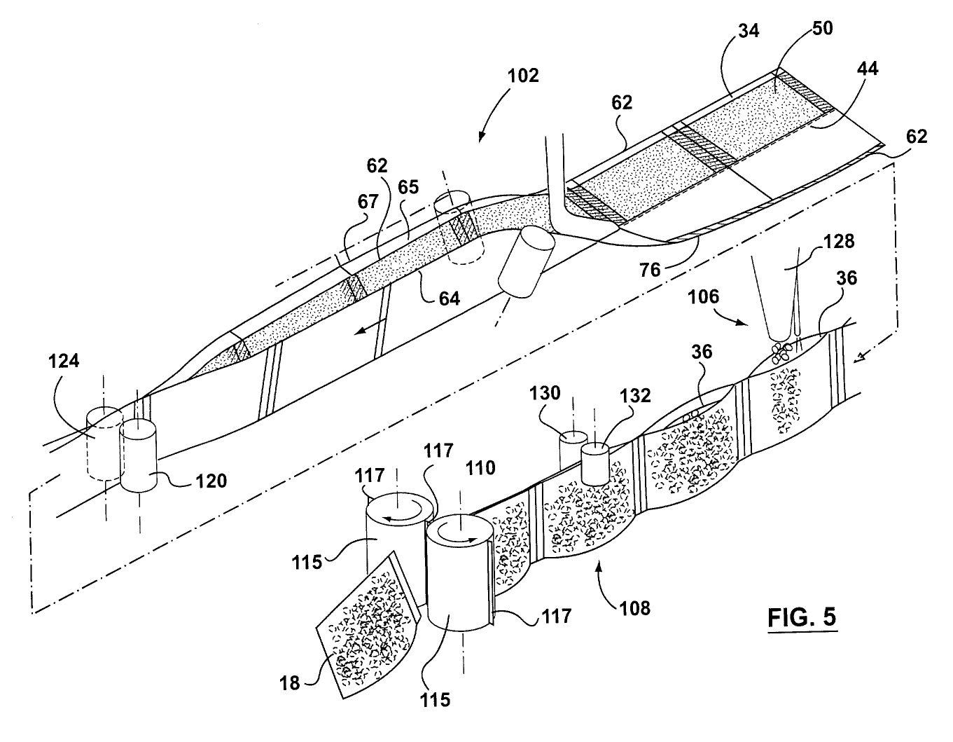

With reference now to FIG. 5, a method and apparatus for forming pouches 18 using the web 34 of FIGS. 3 and 4 is illustrated schematically. Web 34, with paper layer 50 positioned upwards, moves horizontally to a folding station 102 wherein the upper and lower portions of the web are folded vertically along medial fold line 44. Additionally, tab 65 is folded inwards about transverse folding line 67. After having been orientated vertically, web 34 is then passed through heat rollers 120, 124 which are arranged so as to activate the adhesive strips 40 and 42 but not strips 76 so as to form a series of pocket portions 36. Pocket portions 36 are thus closed on three sides—at the bottom by the fold of the web 34 and on the sides by seals provided by adhesive strips 40 and 42 bonding the inner face of the web to itself along two transverse strips. Thereafter web 34 is fed to filling station 106 wherein each of pockets in turn is filled from a corn kernel and charge dispenser generally designated 128 through the top opening in each pocket portion 36.

Thereafter each of the filled pockets 36 is fed to a top seal sealing station 108 wherein the heat activated rollers 130 and 132 activate heat activated adhesive strip 76 to seal pocket 36 along the top edge. After leaving top sealing station 108, web 34 has been transformed into a series of completely sealed pockets 36, each pocket having been filled with popcorn kernels and charge. Finally, web 34 is passed to cutting station 110 wherein each of the individual pockets 36 is cut from the web to form a series of individual pouches 18. A fully formed pouch 18 is illustrated in FIG. 6.

Alternate pouches 118 and 218 are shown in FIGS. 6a and 6b respectively. Pouches 118, 218 can be formed using a similar process to the formation of pouch 18, with the webs 134 of FIG. 3a and web 234 of FIG. 3b. However, no corresponding top fold is made; the only folds made are about axes 144 and 244 respectively.

It will be appreciated that the process illustrated in FIG. 5 can be easily modified to produce the alternate pouches of FIGS. 6a and 6b.

Other configurations and designs of inner pouch 18 are possible. The important features are that it be able to store the popcorn kernels properly before cooking in the microwave oven, as well as possible a charge, like for example cooking oil. Additionally, the inner pouch 18 must be capable of opening up to release the popcorn into the outer container 14 during heating by a heat source. Although the material from which inner enclosure 18 made may be sufficiently flexible in itself, to permit is to provide an opening during the heating process, a similar functionality could be accomplished with a material that is quite rigid. For example, a pouch may be made from a more rigid material with a portion having a hinge mechanism associated with it, so that the hinged portion of the pouch material can pivot from a closed position to an open position during the heating process (ie. like a hinged door mechanism).

In addition to the method of forming pouches 18, 118 and 218, with webs 34, 134 and 234 disclosed herein, other methods of making an inner pouch are also contemplated to be within the scope of the invention.

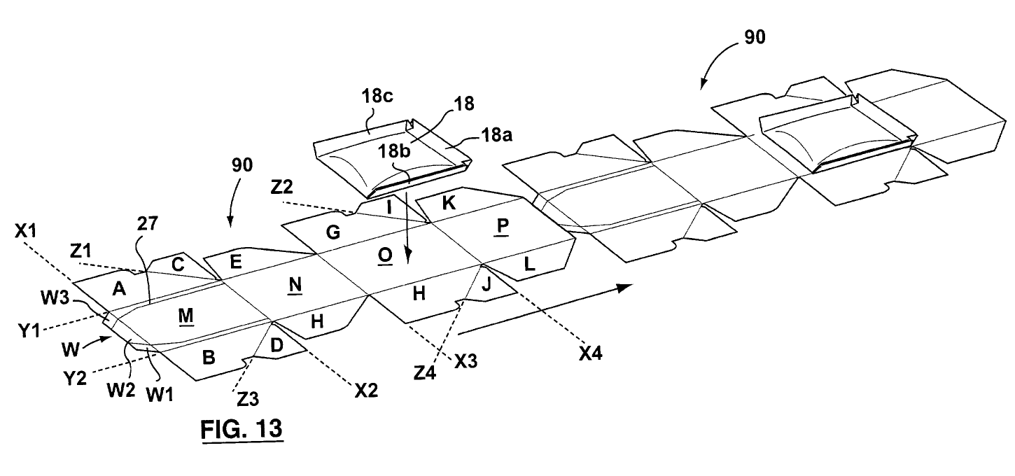

Outer enclosure 14, is made from a blank 90 (FIG. 13). The material it is made from may be cardboard. However, enclosure 14 could be made from other suitable materials. It is important that the outer enclosure not prevent the susceptor from generating sufficient heat to cook the popcorn kernels. Accordingly, the outer enclosure 14 may be made from a material that is transparent or semi-transparent to microwave radiation (referred generally herein to as being microwave transparent or transmissible).

The enclosure 14 should be sufficiently rigid that it can form a self-erecting enclosure. It is also configured such that it can be deflected or moved from one configuration to another. This can be accomplished, for example, by selecting a material, which is semi-rigid, such that one part can move or pivot relative to another such as by pivoting about fold lines. Cardboard is such a suitable material.

Enclosure 14 should also have some form of venting mechanism, so that when the popcorn is being generated inside the internal cavity, the pressure does not become too high. It has been found that, the in the specific embodiments described herein that utilize a plurality of interconnected panels, gaps inherent in the configuration provide sufficient venting of the internal cavity during cooking of the popcorn kernels.

Enclosure 14 may also have a mechanism for maintaining the enclosure in its erected configuration. Also, enclosure 14 may be configured so that when erected, it can maintain itself in a self-standing or self-supporting position. Enclosure 14 typically has printed marketing, brand information or the like applied to or formed on it. The actual printing itself, as for example silk-screened printing on the cardboard, may provide a significant degree of protection from grease seepage though the walls of outer enclosure 14. If desired, it is also possible to coat an inner and/or outer surface of enclosure 14 with a plastic type coating, paperboard coating or other coating which is relatively impermeable to the charge.

With reference now to FIGS. 13-18, one suitable method in which container 10 may be formed from a blank 90 and pouch 18 is schematically illustrated. Of course, this would typically be done in a continuous operation using a conveyor system to carry out the operation on a plurality of blanks in turn. Blanks 90 can be part of a continuously connected series of blanks, which are cut during the forming process into individual blanks. Alternatively, individual blanks can be handled in series in the process.

Blank 90 comprises a plurality of panels A-P and a tab W comprising tab portions W1, W2 and W3. It will be appreciated from the description that follows that panel O can be considered a bottom panel, panel M a top panel, and panels N and P form two of the side walls for container 14. The remaining two side walls are created by the interaction of panels A, C, E, G, I and K on one side, and panels B, D, F, H, J and L on the other.

Top panel M has a score line 27 which stretches into tab W to define the tabs W1, W2 and W3. Score line 99 defines a removable lid portion 21 in panel M and tab W.

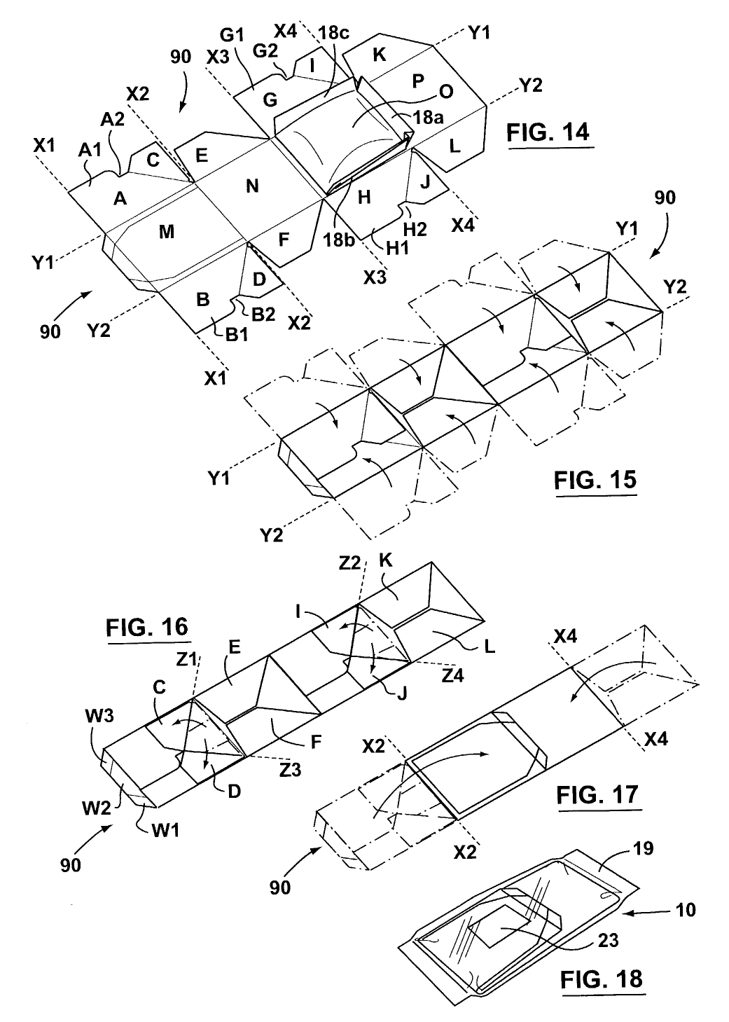

To form the container 10, first, as shown in FIG. 13, pouch 18 is placed onto bottom panel O. The pouch could simply be placed on bottom panel O, but alternately panel O may be affixed on the pouch's bottom portion with a heat resistant adhesive or other suitable securement mechanism. A suitable heat resistant adhesive is glue model number WB 3401 DRR made by HB Fuller Inc. It will be noted that in this embodiment, three tab portions 18a, 18b, and 18c of the pouch, if not folded, would extend beyond the perimeter of panel O. In FIGS. 13 and 14 the tab portions 18a, 18b and 18c of pouch 18 are shown in their folded, trough forming, configuration which results when pouch 18 is placed on the blank 90 and the folding operation described below has taken place. Alternately, the pouch tab portions 18a, 18b and 18c could be pre-formed.

After placement of pouch 18 onto panel O of blank 90, the blank will typically be moved to another station where some folding operations take place. In one embodiment, if blanks are delivered to the folding operation interconnected in series, they will be cut into separate blanks to permit the folding operation to take place, prior to any folding occurring. In this embodiment, the blank 90 is moved in the direction of the arrow shown in FIG. 13. During this movement panels A/C, E, G/I and K are folded about fold line axis y1 onto center panels M, N, O and P, and B/D, F, H/J and L are folded about fold line axis y2 onto the same panels M, N, O and P, as shown in FIG. 15. This can be accomplished using conventional equipment, such as with a conveyor and flap shovel. This folding results in the folding over of tabs 18b and 18c. Blank 90 and pouch 18 are then in the configuration illustrated in FIG. 15. Next, panels C, I, D and J are folded backwards about their respective fold line axes z1 z2 z3 and z4 to take on the configuration shown in FIG. 16. Again, this can be done using conventional equipment such as straight line and right-angled folding equipment.

Thereafter the blank 90 with pouch 18 affixed thereto, is, in one embodiment, transferred to a second conveyor to move the blank at right angles to the movement indicated in FIG. 13, whereby the edge coinciding with axis Y1 is the leading edge of the movement. During this movement, heat resistant adhesive is applied on the upward facing surfaces of panels C, D, I and J. Heat resistant adhesive is also applied to the upward facing surface of outer lid tab portions W1 and W3, but not to lid tab portion W2. The application of the adhesive is not shown, but can be carried out using conventional equipment set up in line on the conveyor system. A suitable heat resistant adhesive would be the same glue model number WB 3401 DRR by HB Fuller Inc.

Next the combination of panels K, P and L is folded about fold line axis x4 and compressed onto panel 0. This fold also folds over tab 18a. The adhesive causes panel K to be secured to panel I, and panel L to be secured to panel H. Finally, panels A, C, M, B, D and tab portions W1, W2 and W3 are folded about fold line axis x2 and compressed onto panels E, N and F. The adhesive on panel C will bond panel C to panel E and likewise adhesive on panel D will bond that panel D to panel F. The adhesive on tab portions W1 and W3 will bond tab W to panel P, thus connecting panel M with panel P.

The formation of container 10 is now complete and as shown in FIG. 18, it is in a flattened configuration suitable for final packaging and shipment.

Container 10 may be wrapped in an outer covering 19, which can be applied using conventional equipment. This covering may be a transparent plastic, which will assist in maintaining the freshness of the food products during storage. The outer covering can hold packets of seasoning or other additives, for the popcorn.

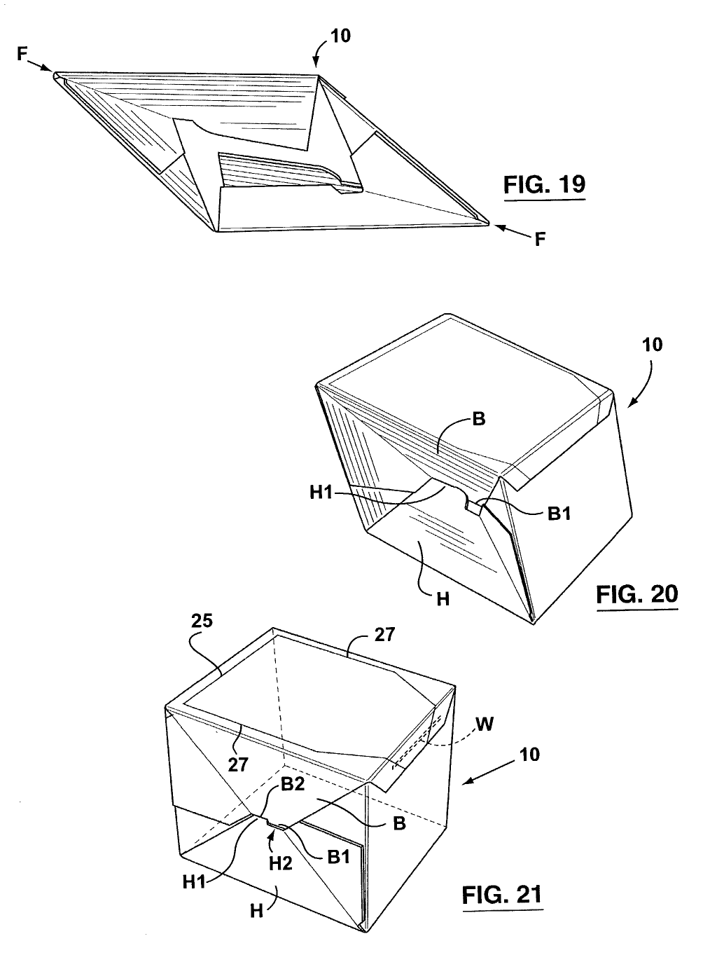

In use, the consumer will take the container 10, which may delivered in its covering in the generally flattened configuration illustrated in FIG. 18, out of its outer covering. By application of forces in the directions shown in FIG. 19, container 10 is moved into a partially erect configuration as shown in FIG. 19, and then to the more erect configuration shown in FIG. 20 and finally to the fully erect configuration as shown in FIG. 21. When in the fully erected configuration, panel portions A and B will be received into a locking engagement with panel portions G and H, respectively, to form two opposite side walls of container 10. Specifically, panel A has a tab portion A1 and notch A2. Likewise panels B, G and H have tabs B1, G1, H1 and notches B2, G2 and H2 respectively. During the erection process, tab portion A1 will slide into notch G2 and tab G1 will slide into notch A2, to provide an interlocking of panels A and G. Similarly, during the erection process, tab portion B1 will slide into notch H2 and tab HI will slide into notch B2, to provide an interlocking of panels B and H. This provides interference fits between interlocking of panels A,G and B,H which will assist in maintaining container 10 in its erect configuration during normal use. It should also be noted that upon being moved to the fully erect configuration, middle tab portion W2 will not be glued down and preferably actually remains close to, if not in, the same plane as top panel 20, as best shown in FIG. 1.

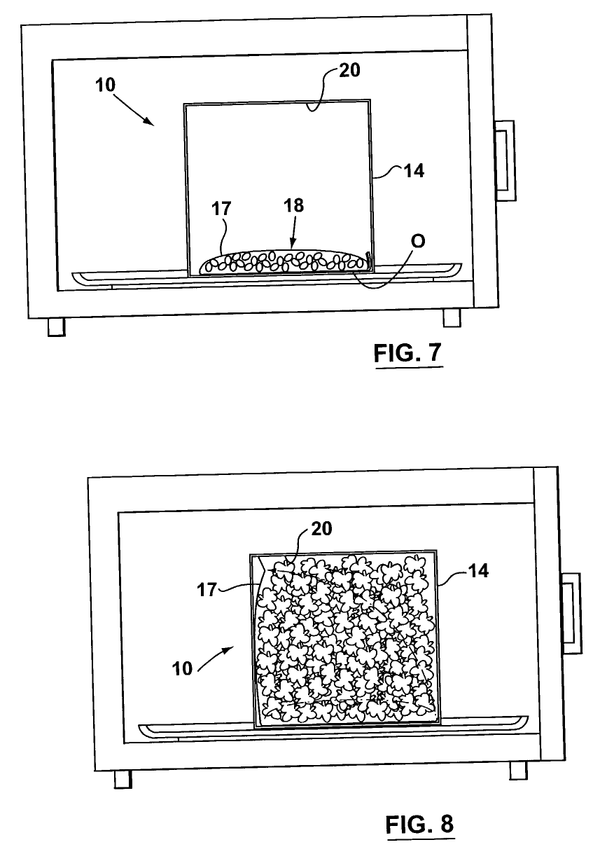

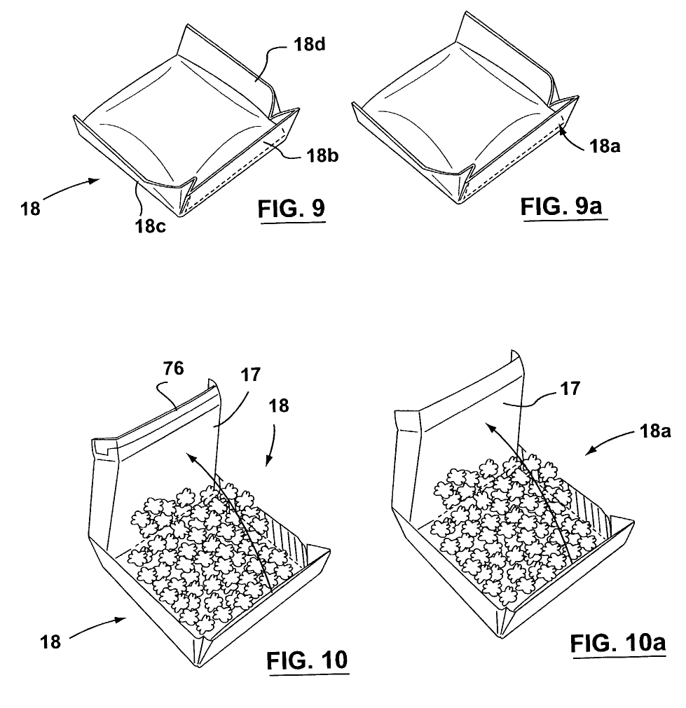

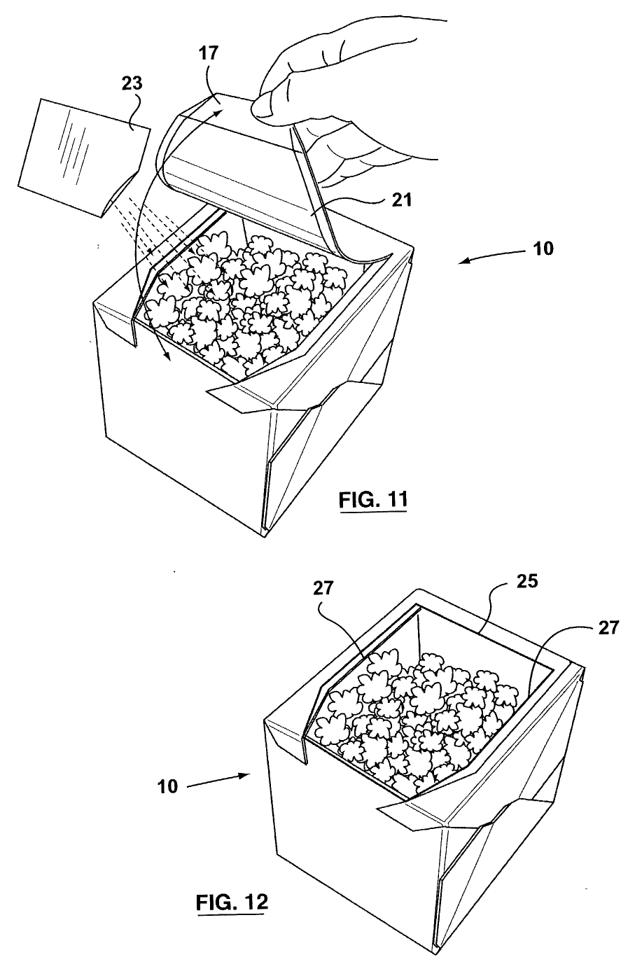

With reference to FIGS. 7 and 8, the use of container 12 in a microwave oven is disclosed. Having been put into the fully erect position, enclosure 14 containing pouch 18 is placed in the microwave, usually with its base panel O resting on the bottom inner wall of the microwave oven, as seen in FIG. 7. Once the microwave oven is turned on and microwave radiation is emitted, the radiation will pass through outer enclosure 14 and will be absorbed by the susceptor material in pouch 18. Significant heat will be generated by the susceptor causing the popcorn kernels to heat up. Steam is then created within the kernels causing the kernels to pop and steam is emitted into the inner cavity of pouch 18, thereby increasing the internal pressure in the cavity of pouch 18. Also, the heat generated will cause the heat seals that were formed with the heat activated adhesive to soften. As the pressure in pouch 18 increases, the seals made with heat activated adhesive around the pouch perimeter will release. As the heating process continues, more and more kernels will be heated causing the top panel section 17 of pouch 18 to be extended to the position shown in FIG. 8. As the top panel of the pouch 18 is pushed upwards, it will become wedged against an underside portion of top panel 20 of enclosure 14. This serves to maintain the top panel 17 in an open position and prevent it from falling down as popcorn is removed from the container.

In the embodiment just described, it is the combination of the increased heat in pouch 18, as well as the increase in pressure within the pouch, that causes the seal to release. In other embodiments, the pouch can be configured so that the material is weakened in an area so that it is only the increase in pressure which causes the pouch to open (eg. the pouch does not create an opening due to the release of a heat activated adhesive seal). The pouch could be constructed with an area of material that is weakened and is specifically designed to fail when the internal pressure increases.

Another desirable feature of pouches 18 and 18a, is that the trough formed by the folding over of tabs 18a, 18b and 18c is maintained during the release process, thus preventing significant amounts of oil and grease from escaping from the pouch, and thereby preventing significant soiling of the outer enclosure. However, there are alternatives to providing a pouch with a trough. Also, in some embodiments, it is not necessary to provide a grease barrier at all.

Once the heating process is completed the container can be taken out of the microwave oven. Middle tab portion W2 provides a handle for gripping the container when removed from the microwave oven, and helps to minimize the risk of scalding from steam continuing to be released from the container, or burning from the heated panels, which have been heated by the hot popcorn.

As shown in FIG. 11, the lid portion 21 can be lifted away from the front along the side score lines 27 to provide an opening through which seasonings from packet 23 (which could have been housed in the previously described outer covering for container 10) can be added to the popcorn. Once the seasonings have been added, lid 21 can be temporarily held down, and the contents of enclosure 14 shaken to evenly distribute the seasonings throughout the cavity of the enclosure. It should be noted that as depicted only in FIG. 21, preferably, tab portion W2 can be folded into a transverse slot 31 in side panel 24 (only shown in FIG. 21), to hold the lid temporarily in place while container 10 is shaken. Slot 31 usually would be preformed in the blank 90. This temporary securing of tab portion W2 into slot 31, can also be used to hold down the lid during temporary storage of the container 10.

Finally, the lid 21 can be reopened to permit removal of the popcorn. If desired, lid 21 can be completely removed by tearing along the rear, transverse portion of score line 27.

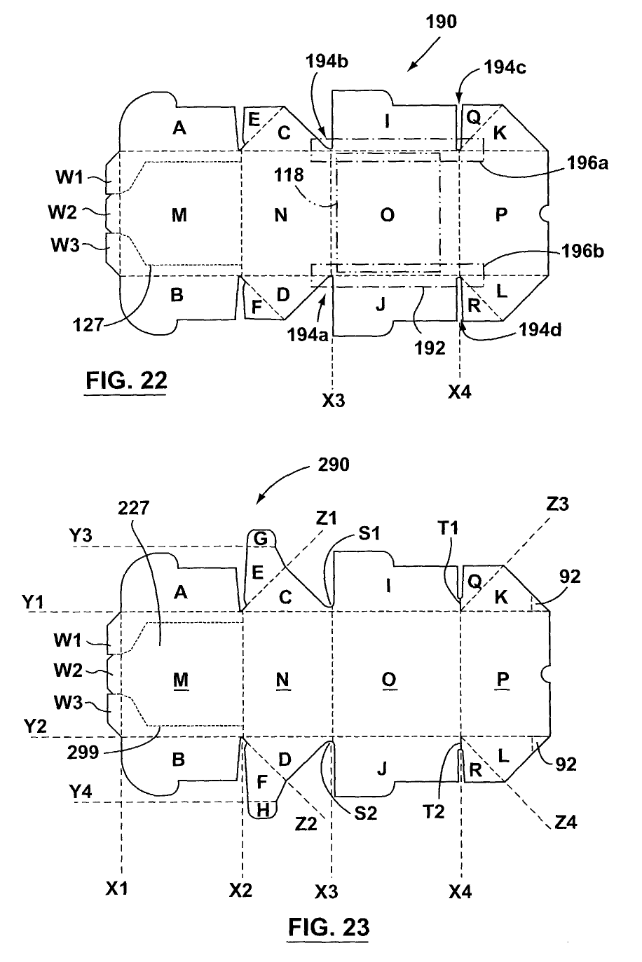

Referring now to FIGS. 22, an alternate blank 190 for use in making a container, similar to container 10, is disclosed. Blank 190 comprises a plurality of panels A-P and a tab W, comprising tab portions W1, W2, and W3. As with blank 90, blank 190 has a removable lid portion on top panel M. Blank 190 is similar to blank 90 described above and can be formed into a container using a process somewhat similar that described above for blank 90. During the forming process, a pouch 118 (shown in ghost line) is affixed to base panel O of blank 190. Pouch 118 constructed like pouches 218 described above and illustrated in FIG. 6b, and is positioned with its opening adjacent fold line axis X3. In this way, during heating in the microwave oven, the pouch will open such that its upper panel will lift up and be pushed backwards towards the side wall formed from panel P.

It will be observed that gaps 194a, 194b, 194c, and 194d exist between panels D/J, C/I, I/Q and J/R respectively. At the innermost part of the gaps 194a-d, there will be an unsealed join between base 0 at its corners where it meets the side walls, when the container is in the erected configuration. This provides a possible location for a leakage of grease or the like, if the inner pouch 18 is not configured to provide a trough to contain such materials. Therefore, a barrier can be provided at the corners of base panel O, to inhibit leakage through gaps 194a-194d. In the embodiment shown in FIG. 22, the barrier comprises lengths of adhesive tape (such as a plastic adhesive tape). Tape 196a is secured to panels C, N, I, O, Q, K and P, and tape 196b is secured to panels D, N, J, O, R, L and P in the positions illustrated. In this way gaps 194a-d may be sufficiently blocked to inhibit grease passing outside of the internal cavity of the box, formed from blank 190, during use.

It will however, be appreciated that the panel-folding operation may be made more difficult by this taping. In an alternate embodiment to provide a complete barrier, the blank 290 may be employed.

Referring now to FIGS. 23 to 29, blank 290 when formed in to a container, provides a similar trough in the base of the erected container. This trough is created by the blank 290 itself, and not by the pouch inside the outer enclosure. The trough in blank 290 is created by using interconnecting webbing S1, S2, T1 and T2 between the panels of blank 290. This webbing consists of integrally formed continuations of the cardboard material forming the rest of the blank 290, between adjacent panels.

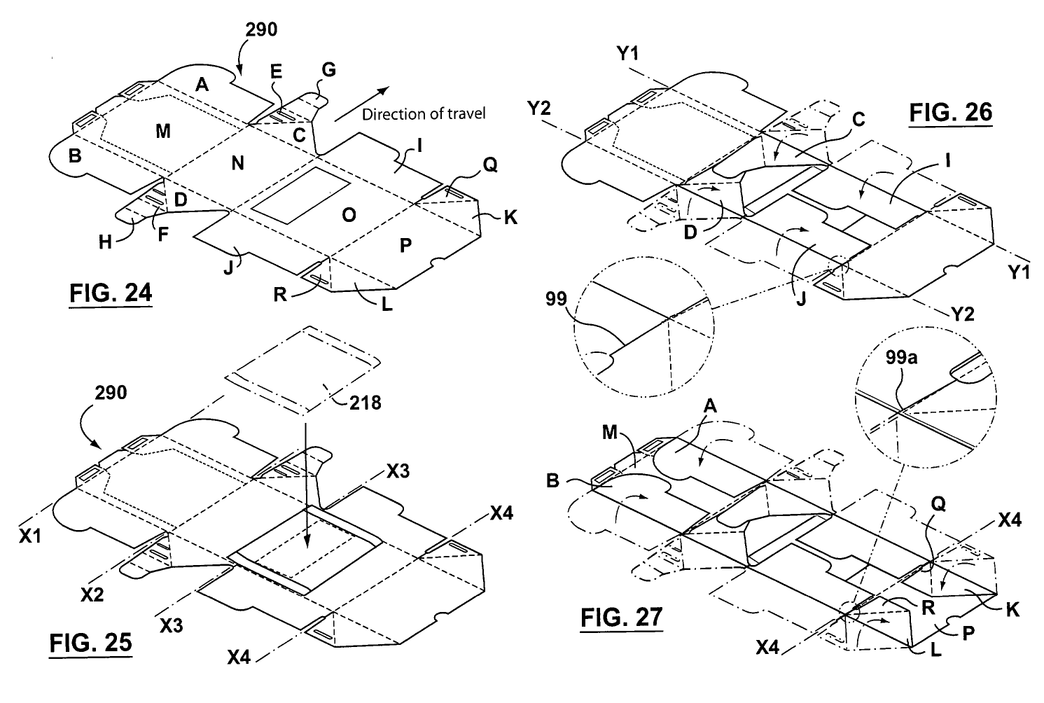

The forming sequence using blank 290 will now be described. Pouch 218 (which is constructed like pouch 118 in FIG. 6b) (FIG. 25) is positioned on panel O and preferably affixed there using appropriate heat resistant glue or other suitable attachment mechanisms. Pouch 218 may be positioned so that its front edge is adjacent folding axis X3. After placement of pouch 218 onto blank 290, the blank is then moved in the direction of the arrow shown in FIG. 24. During this movement panels C/E/G and I are folded about axis y1 onto center panels N and O respectively, and panels D/F/H and J are folded about axis y2 onto center panels N and O respectively, as shown in FIG. 26. The folding of these panels at the same time keeps the interlocking webbing S1 and S2 intact. As will become apparent, the interlocking webbing S1, S2 will prevent liquid from escaping at the corners when the container is erect and pouch 218 opens to release the popcorn.

Interconnecting webbing T1 and T2, will rip apart during the presently described folding process. However, during the ripping of webbing T1, T2 that occurs in this folding operation, a plurality of fibers are formed at the cut seam 99, 99a and extend outward from one panel toward the adjacent panel. In this way, even though a rip is formed between the adjacent panels at T1, T2, the fibers tend to provide a barrier that can absorb small amounts of liquids/grease that might migrate to those corners of the base panel. It will be appreciated, however, that since pouch 218 is spaced from folding line X4, and since the pouch fold line 244 (FIG. 3b) of the pouch 218 is closest to blank 290 fold line X4, there is in most situations, little if any such grease or the like that will actually migrate to the corners at fold line X4.

Next, panels A and Q/K are folded about axis y1 onto center panels M and P respectively, and panels B and R/L are folded about axis y2 onto center panels M and P respectively, as shown in FIG. 27. Blank 290 and pouch 218 are then in the configuration illustrated in FIG. 27. Next, panels G/E, F/H, Q and R are folded backwards about their respective axes z1, z2, z3 and z4 to take on the configuration shown in FIG. 28. The above processes can be accomplished using conventional equipment, such as a conveyor and flap shovels.

Next, heat resistant adhesive 296 is applied on the upward facing surfaces of panels Q, R, E and F. Heat resistant adhesive 295 is also applied to the upward facing surface of the outer lid tab portions W1 and W3, but not to lid tab portion W2. The application of the adhesive is not shown, but can be carried out using conventional equipment set up in line on the conveyor.

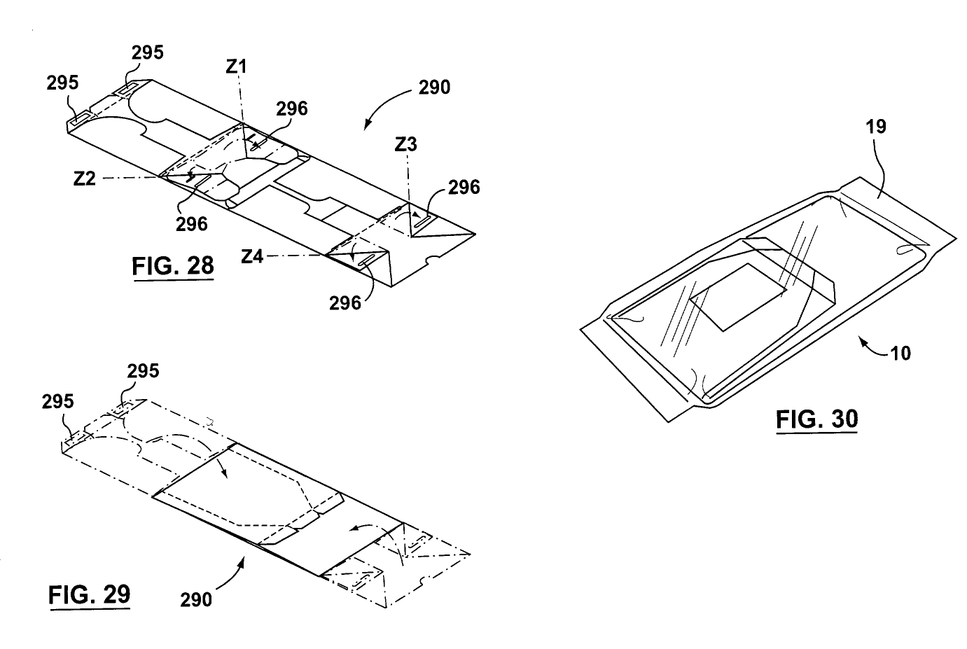

Next the combination of panels Q, K, P, L and R is folded about axis x4 and compressed onto the combination of panels I, O and J. The adhesive causes panel Q to be secured to panel I, and panel R to be secured to panel J. This step is illustrated in FIG. 29. Finally, panels A, M, B and tab portions W1, W2 and W3 are folded about axis x2 and compressed onto panels G, E, C, N, D, F and H. The heat resistant adhesive on panel E will bond panel E to panel A. Similarly, heat resistant adhesive on panel F will bond panel F to panel B. The heat resistant adhesive on tab portions W1 and W3 will bond tab W to panel P, thus connecting panel M with panel P as illustrated in FIG. 29.

Since the heat resistant adhesives make take some time to set, the package in the form shown in FIG. 29 can then be fed between a set of rollers that compresses the package together and permits adhesives, particularly heat resistant adhesives 295, 296, to properly set.

The formation of container 10 is now complete and as show in FIG. 30, it is formed into a flattened configuration suitable for final packaging and shipment. Again, the above folding and gluing processes can be accomplished generally by using conventional equipment.

In an alternate folding process, the folding of the panels is such that noen of the interlocking webbing S1, S2, T1 and T2 tears. In this alternate embodiment (not shown in the drawing), panels C/E/G, I and Q/K are folded about axis y1 onto center panels N, O and P respectively, and panels D/F/H, J and R/L are folded about axis y2 onto center panels N, O and P respectively. Next, panel A is folded about axis y1 onto the center panel M, and panel B is folded about axis y2 onto the center panel M. After these folding operations, the process to create the container is the same as described above in the previous embodiment. In this embodiment the interlocking webbing S1, S2, T1 and T2 will not tear. This creates a liquid impermeable trough in the base of the erected container. Also, in this embodiment, a portion of panels K and L closest to the container edge is provided with notches 92 as shown in FIG. 23 in ghost lines, so that panel P extends farther longitudinally than the panel K and L. This facilitates the holding of the blank at the ends of panel P and with tabs W1-3, during the folding operation (ie. the blank can be held at the ends and not on any of the panels which need to be folded). With this last modification, the above process can be accomplished using conventional equipment, such as a conveyor and flap shovel.

It should be noted that blank 290 also has score lines 227 in panel M, extending into tab W, that will provide for a removable lid portion, as in the embodiment described above.

As in the previous embodiment, the container 110 formed with blank 290 and pouch 218, can be wrapped in an outer wrapper, which can be applied using conventional equipment. This covering is preferably a transparent plastic, which will assist in maintaining the freshness of the food products during storage, and serve as extra protection against leakage during shipping and storage, prior to use. However, it has generally been found that the inner pouch will provide an adequate degree of freshness protection in many circumstances.

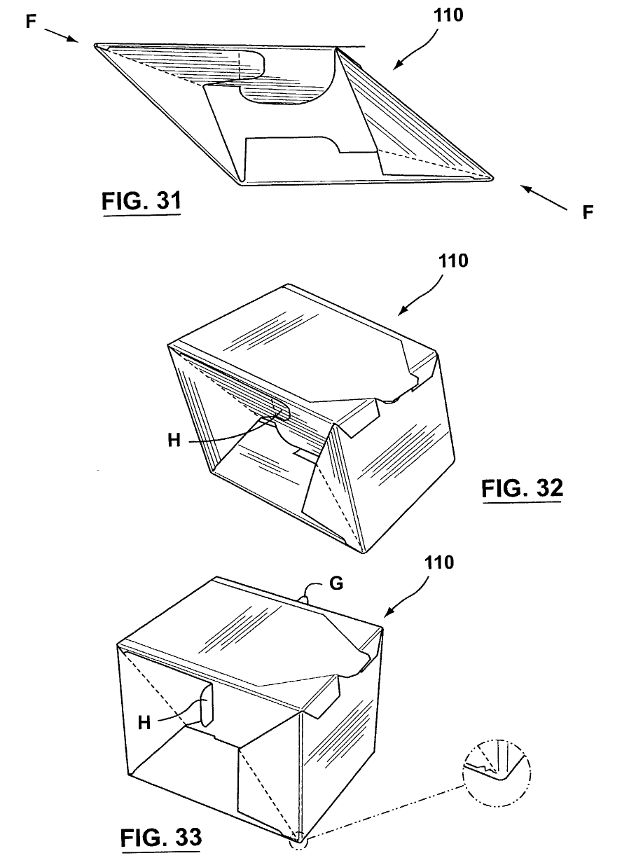

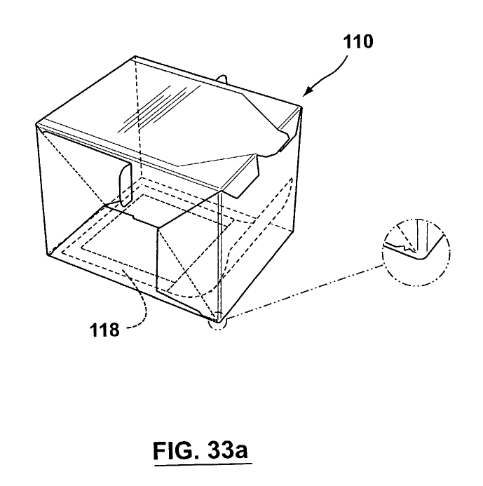

In use, the consumer will take the container 110, made from blank 290, which is delivered in its outer covering, in the flattened configuration illustrated in FIG. 30, out of its outer covering. FIGS. 31 to 33 illustrate the erection of the container 110 which occurs as described above, in conjunction with container 10 and Figures. Upon erection, the panels G and H in the form of tabs are readily accessible by the consumer, and can be folded outwards along axes y3 and y4 (see FIG. 23) before the container is subject to microwave radiation. The consumer can use these tabs for holding the container after heating in the microwave oven, if the container is hot. The detail in FIG. 33 also illustrates the placement of the fibers that were created by the ripping of the adjacent panels in the folding process. These fibers will tend to absorb liquid that may have a tendency to escape through the corner seams of the erected container.

In FIG. 33a, a container made using blank 190 is shown after having been subjected to heating in a microwave oven (popcorn removed for clarity).

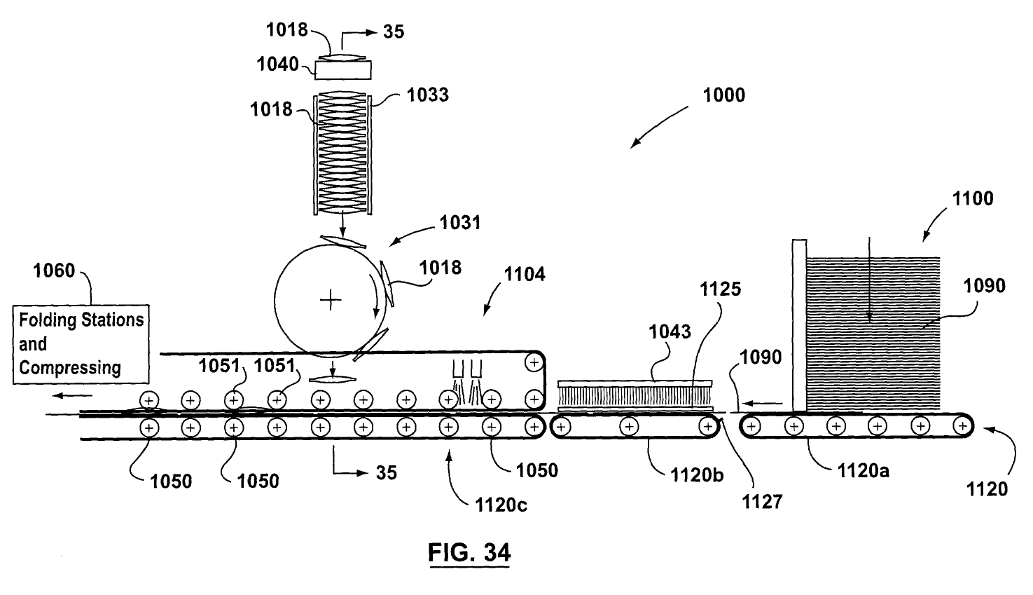

With reference to FIG. 34, a general layout of part of a container forming apparatus is disclosed. This apparatus 1000 generally comprises a blank magazine 1100 holding a plurality of blanks 1090, a conveyor system 1120, a rotary pouch feeder 1031, a pouch magazine 1033, a pouch conveyor 1040 and folding and compressing stations collectively designated 1060.

A blank 1090 is taken from the bottom of a stack of blanks in magazine 1100 and is carried by the first part 1120a of conveyor system 1120, which comprises a conventional belt conveyor system, in the direction of the arrow indicated in FIG. 34 toward pouch feeder 1031. As described previously, the blanks may be moved along the conveyor path, oriented transversely.

Blank 1090 first passes from continuous conveyor 1120a to rest temporarily on a dead plate 1125 under brushes 1043. Brushes 1043 maintain blank 1090 in a generally flat orientation. Continuous conveyor 1120 has a belt carrying one or more timing lugs 1127 that rotate and lugs 1127 pass through a slot in plate 1125 to engage blank 1090 and push it onto conventional belt conveyor 1120c. In this way the position of each blank if properly timed in relation to the rest of the apparatus downstream.

As blank 1090 is moved by continuous conveyor 1120c, it passes a station where heat resistant glue is applied to panels of the blank 1090 in locations described above, at the glue station 1104. It will be appreciated that some aspects of the glue application can take place further along the manufacturing line.

Pouches 1018 are continually being fed into a pouch magazine 1033. Rotary pouch feeder 1033 takes pouches 1018 serially from the magazine 1033 and then transfers a pouch 1018, onto a medial panel of the blank, in the position described above. In this embodiment, this process is done continuously without stopping, with continuous movement. The conveyor system using rollers 1050 and 1051 drives the blank 1090 and pouch 1018 forward to the folding and compression stations. The rollers 1050 and 1051 can be arranged so as not to interfere with the folding operation.

The panels are folded in a process described above using conventional types of equipment. Additionally a known type of compression apparatus can be provided to ensure that the heat resistant glue properly bonds together the respective parts of the container. It should be noted that the order of the processes described above is only one embodiment and variations and modifications can be made without deviating from the scope of the claims.

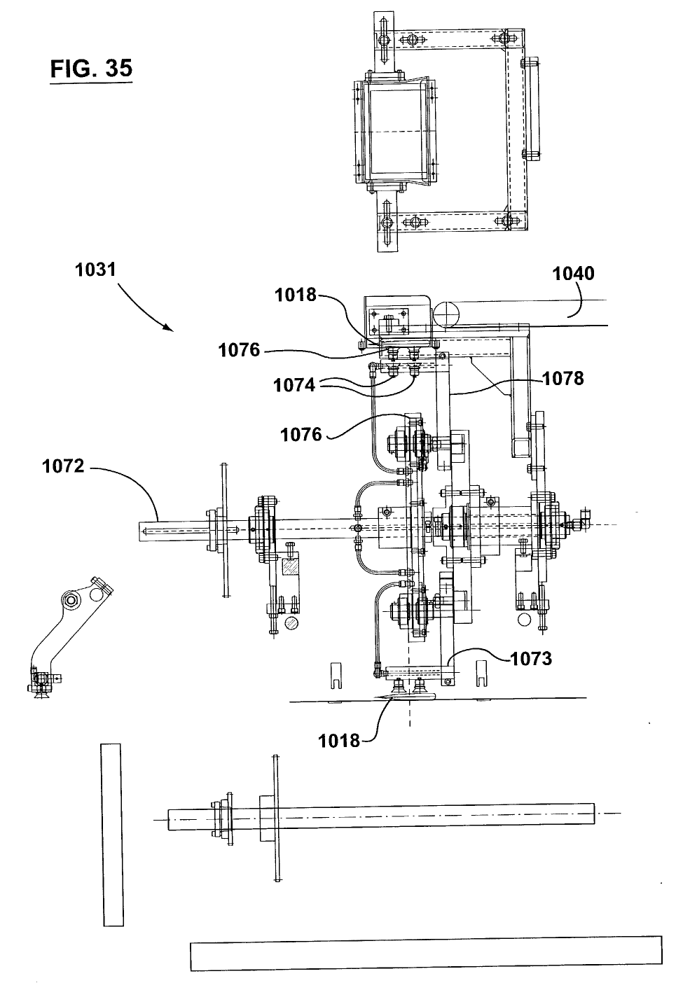

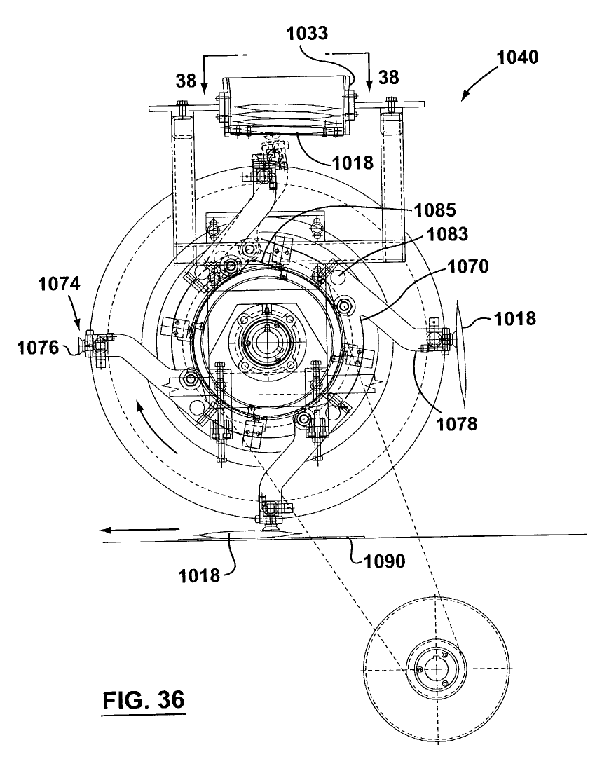

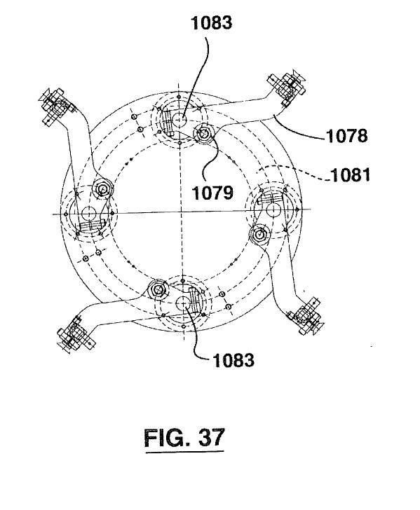

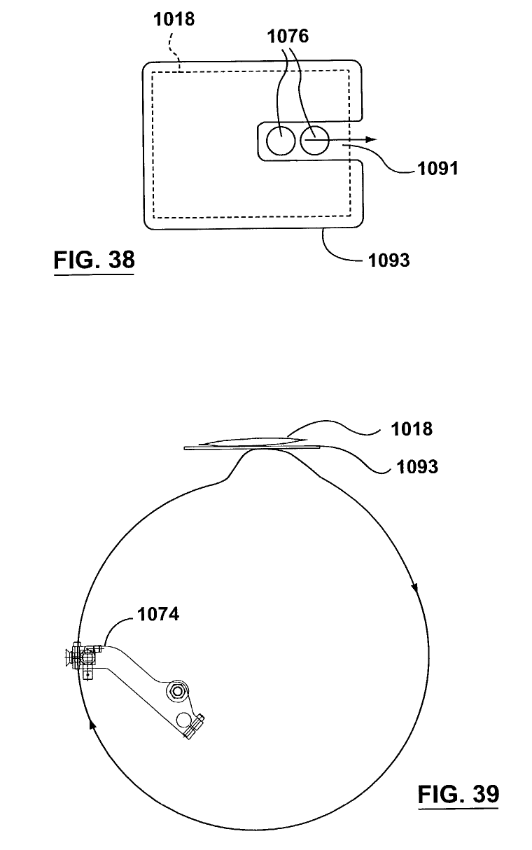

With reference to FIGS. 35 to 39, an example of a rotary pouch feeder 1031 is illustrated. Feeder 1031 comprises a rotatable disc mounted on a drive shaft 1072, driven by conventional drive motor and belt. Mounted to disc 1070 are a plurality (in this embodiment four) arm members 1078 which serve to support at their ends pick up heads 1074. Each pick up head 1074 has an outwardly facing pair of suction cups 1076 adapted to retrieve pouches from magazine 1033 and transfer them to a position where they are deposited onto a blank 1090. Arms 1078 are mounted to disc 1070 for pivoting, cam actuated vertical movement at the 12 o'clock position to assist in the retrieval of pouches out of magazine 1033. This is achieved as follows. Each arm 1078 has a cam follower 1079 which is received in a cam track 1081. At the 12 o'clock position cam track 1081 deviates from a circular track at a cam surface 1085, causing arm 1078 to pivot about a pivot location 1083. This causes a deviation in the path of the pick up head from a circular path, as shown in FIG. 39. As a result, the pick up head moves toward pouch magazine 1033 and suction cups 1076 are able to attach onto a pouch by engaging pouch 1018 through a slot 1091 located in a bottom plate 1093 of magazine 1033. Thus the suction cup 1076 will momentarily come into contact with a pouch 1018 and then once it has retrieved it, moves on a path reflected by the path of the pick up member shown in FIG. 39.

Air suction is generated at suction cups by the supply of compressed air through hollow shaft 1072, through a series of air tubes connected with pivot connectors to vacuum generators 1073. Vacuum generators 1073 convert the pressurized air to suction at the ends of the suction cups 1076.

The application of suction can be controlled by valves, which can be electronically controlled.

As described above, the container as described above, can be supplied directly to a consumer of the product (eg. an individual who wishes to consume the product at home). In such a situation, the consumer would purchase the container in the flattened container and then typically use their own or some other personal microwave to create the microwave popcorn.

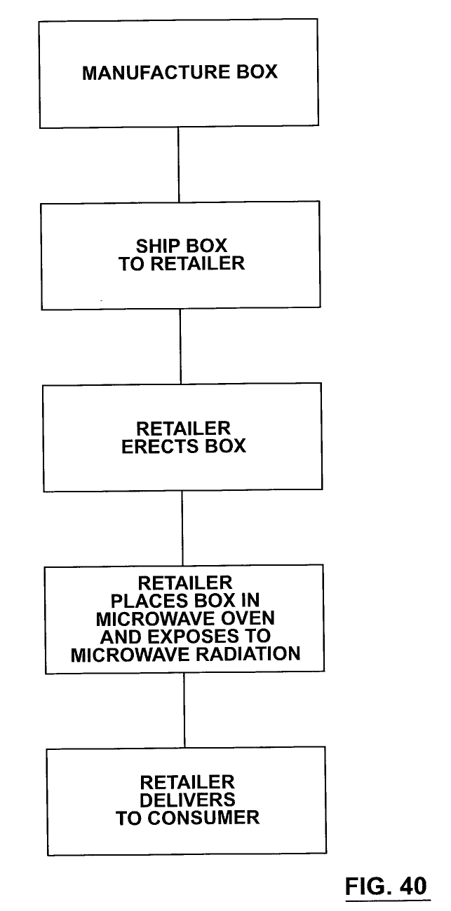

However, the containers described above enable other new methods of carrying on business to be conducted. As illustrated in FIG. 40, a manufacturer can make a container like container 10 or 110, as described above. This container, or a plurality of such containers, can be shipped to a retailer of some kind. The retailer could be a restaurant such a fast food outlet, a movie theater, or other retailer. As the containers are delivered to the retailer in a generally flattened configuration, the overall shipping and storage capacity required is minimized.

When a consumer visits the retailer, the retailer can then take out the flattened box from storage, take off the protective covering if any an erect the box. The retailer can then use their own microwave or other heating device to create the popcorn and then deliver the ready to eat popcorn in its container.

It is contemplated that various modifications could be provided without deviating from the scope of the invention, as defined by the claims that follow hereafter

I claim:

1. A container for use in making popcorn in a microwave oven, said container comprising:
a) An outer enclosure enclosing an outer cavity, said outer enclosure made from a rigid or semi-rigid microwave transparent material;
b) An inner enclosure enclosed within said outer cavity and enclosing an inner cavity, said inner enclosure including a base portion with a susceptor for absorbing microwave radiation to heat popcorn kernels located in the vicinity of said susceptor, said inner enclosure having an opening sealed by a seal;
c) a plurality of un-popped popcorn kernels and a charge enclosed in said inner cavity, wherein at least some of said plurality of kernels will pop and expand when said container is subjected to microwave radiation, and wherein the pressure in said inner cavity will increase and said seal will be released to release said popped kernels from said inner enclosure within said outer cavity;
said outer enclosure and said inner enclosure being adapted such that said outer enclosure is movable, by application of external forces to said outer enclosure, from a first configuration wherein said outer enclosure and said inner enclosure are in a generally flattened configuration to a second configuration wherein said outer enclosure is in an erected configuration and said outer cavity has increased in size so as to accommodate said popped kernels released from said inner cavity.

2. A container for use in making popcorn in a microwave oven, said container comprising:
a) a self erecting container made from a microwave transparent material and having an expandable internal cavity, said container being movable from a first generally flattened configuration to a second erected configuration, whereby the size of said cavity is increased;
b) an inner pouch containing a plurality of popcorn kernels and an associated charge, said pouch having a susceptor for absorbing microwave radiation to heat said kernels, and said pouch being located within said expandable cavity, wherein at least some of said plurality of kernels will pop and be released by said pouch within said cavity, when said container is subjected to microwave radiation.

3. A container as claimed in claim 1 wherein said microwave transmissible material is a cardboard.

4. A container as claimed in claim 1 wherein said cardboard is coated on at least one side with a grease resistant coating.

5. A container as claimed in claim 1 wherein said seal at said opening is formed with a heat activated adhesive, such that when said container is subjected to microwave radiation, said adhesive will soften to release said seal.

6. A container as claimed in claim 1 wherein said inner enclosure is formed with a generally rectangular or square configuration and is sealed on three sides thereof.

7. A container as claimed in claim 1 wherein said outer enclosure has a base and said inner enclosure is affixed to said base.

8. A container as claimed in claim 6 wherein said outer enclosure has a square or rectangular base and a side wall surrounding and extending up from said base, and wherein said inner enclosure is affixed to said base at a bottom panel, and said bottom panel extends beyond said base of said outer enclosure to provide a trough above said base.

9. A container as claimed in claim 1 wherein said outer enclosure has a base and a side wall surrounding and extending up from said base, and wherein said inner enclosure is affixed to said base at a bottom panel, and said bottom panel extends beyond said base of said outer enclosure to provide a trough above said base.

10. A method of forming a pouch for use in a microwave popcorn container from a longitudinally extending web, said web comprising:
a) A longitudinally extending base layer, said base layer having a longitudinally extending medial folding line;
b) A susceptor material bonded to and stretching along one half of a first side of said base layer;
c) A first strip of heat activated adhesive located on said opposite side to said first side, and extending longitudinally, proximate an upper edge on said opposite side of said base layer;
d) A series of transversely extending strips of heat activated adhesive located on said opposite side, said strips extending from a lower edge located opposite to said upper edge, to a position past said folding line;
said method comprising the steps of:
i. moving said web longitudinally
ii. folding said web about said medial folding line such that said upper portion of said opposite surface faces said lower portion of said opposite surface
iii. activating said heat adhesive to bond said lower portion to said upper portion along said transverse strips of adhesive to form a plurality of pockets closed along a bottom and both opposite side of said pockets
iv. moving said pockets horizontally with the open side of each of said plurality of pockets generally oriented upwards
v. filling each of said pockets with a plurality of un-popped popcorn kernels and a charge
vi. sealing the upper side of said pocket
vii. transversely cutting each of said pockets through at a medial position along said side seals to cut a plurality of sealed pouches from said web.

11. A method of forming a pouch for use in a microwave popcorn container from a longitudinally extending web, said web comprising:
a) A longitudinally extending base layer, said base layer having a longitudinally extending medial folding axis and a first side and a second opposite side;
b) A susceptor material secured to at least a portion of said first side said base layer;
said method comprising the steps of:
i. moving said web substantially horizontally;
ii. folding said web transversely about said longitudinally extending medial axis such that an upper portion of said opposite surface faces a lower portion of said opposite surface
iii. bonding said lower portion at discrete locations to form a plurality of pockets, said pockets being closed along a bottom edge and along opposite side edges of said pockets, and having an upwardly directed opening;
iv. moving said pockets horizontally to a filling station and filling each of said pockets through said opening with un-popped popcorn kernels and a charge;
v. sealing the opening of said pocket
vi. transversely cutting said web at a side edge of each of said pockets to cut a plurality of sealed pouches from said web.

12. A web for use in forming a pouch to hold popcorn kernels, said web comprising:
a) A longitudinally extending base layer, said layer having a longitudinally extending medial line;
b) A susceptor material bonded to and stretching along one half of a first side of said base layer;
c) A first strip of heat activated adhesive located on said opposite side to said first side, and extending longitudinally, proximate an upper edge on said opposite side of said base layer;
d) A series of transversely extending strips of heat activated adhesive located on said opposite side, said strips extending from a lower edge located opposite to said upper edge, to a position past said medial line.

13. A web for use in forming a pouch to hold popcorn kernels, said web comprising:
a) A longitudinally extending base layer having a first and second side, said layer having a longitudinally extending medial line and being made from a foldable material;
b) A susceptor material stretching along one half of said first side of said base layer;
c) A continuous strip of heat activated adhesive located on said second side which is opposite to said first side, and extending from a first position on said medial line, toward an upper edge of said web and thereafter to a second position on said medial line.

14. A pouch comprising:
a) A longitudinally extending base layer having a first outer side and a second inner side, said layer having a longitudinally extending medial fold line and being made from a foldable material;
b) A susceptor material positioned on a portion of said first side of said base layer;
c) A continuous strip of heat activated adhesive located on said second inner side which is opposite to said first side, and extending from a first position on said medial line, toward an upper edge of said web and thereafter to a second position on said medial line, said strip of adhesive bonding a first portion of said inner side to a second portion of said inner side to provide a cavity having a boundary defined by said medial fold line and said strip of adhesive;
d) A plurality of kernels and a charge contained within said cavity;
wherein said adhesive strip will release popcorn formed within said cavity, when said pouch is subjected to microwave radiation.

15. A method of forming a container for use in creating popcorn in a microwave oven, said container comprising an outer enclosure made from a blank and enclosing therein a pouch, said container being adapted to be movable with said pouch enclosed therein from a first substantially flattened configuration to a second erected configuration, said method comprising:
a) moving a longitudinally extending web of blanks to a pouch placement station, each blank having a plurality of panels;
b) placing a releasable pouch containing a plurality of popcorn kernels and a charge, on one of said plurality of panels
c) folding and securing said panels to enclose each said pouch within a cavity formed within said blank.

16. A container for use in making popcorn in a microwave oven, said container comprising:
a) A rigid or semi-rigid, outer housing made from a microwave transmissible material, said housing defining and enclosing an internal cavity; said housing having a tab portion protruding therefrom which is suitable for holding said container;
b) a plurality of popcorn kernels and an associated charge in said cavity,
c) a susceptor for absorbing microwave radiation to heat said kernels, wherein at least some of said plurality of kernels will pop and be released by said pouch within said cavity, when said container is subjected to microwave radiation.

17. A container as claimed in claim 16 wherein said housing is constructed with at least two housing portions joined together with at least one overlapping housing section positioned proximate said tab portion.

18. A container as claimed in claim 17 wherein said tab portion is attached to a removable lid portion, said tab portion permitting said lid portion to be readily opened.

19. A container as claimed in claim 18 wherein said tab portion is receivable in a slot in said housing to retain said lid in a closed position.

20. A container for making popcorn in a microwave open, comprising:
a) an outer enclosure having a first, low volume configuration and a second high volume configuration;
b) a pouch within said outer enclosure, said pouch containing popcorn kernels.

21. The container of claim 20 further comprising a latch for latching said outer enclosure in said high volume configuration.

22. The container of claim 20 wherein said outer enclosure has a pair of side walls which, in said high volume configuration are upstanding, said pair of side walls having co-operating features which latch together in said high volume configuration in order to maintain said outer enclosure in said high volume configuration.

23. The container of claim 22 wherein said pouch is adhered to a base wall of said outer enclosure.

24. The container of claim 23 wherein said pouch extends beyond a periphery of said base wall such that, in said high volume configuration, edges of said pouch extend away from said base wall.

25. The container of claim 20 wherein said container further comprises a susceptor.

26. The container of claim 25 wherein said pouch also contains a charge to facilitate popping of said kernels.

27. The container of claim 20 wherein said pouch has a closed opening which opens when said kernels are popping under the influence of a source of microwave heating.

28. The container of claim 27 wherein said opening is closed by an adhesive of a type which releases in the presence of heat.

29. The container of claim 27 wherein said outer enclosure is formed of cardboard.

30. A container for use in making popcorn in a microwave oven, said container comprising:
a) An outer enclosure defining an outer cavity, said outer enclosure made from a rigid or semi-rigid microwave transparent material;
b) An inner enclosure enclosed within said outer cavity and defining an inner cavity, said inner enclosure having a sealed opening;
c) a susceptor for absorbing microwave radiation to heat popcorn kernels located in the inner enclosure;
d) a plurality of un-popped popcorn kernels and a charge enclosed in said inner cavity, wherein at least some of said plurality of kernels will pop and expand when said container is subjected to microwave radiation, and wherein the pressure in said inner cavity will increase a seal at said sealed opening will be released to release said popped kernels from said inner enclosure to said outer cavity;
said outer enclosure and said inner enclosure being adapted such that said outer enclosure is movable, by application of external forces to said outer enclosure, from a first configuration wherein said outer enclosure and said inner enclosure are in a generally flattened configuration to a second configuration wherein said outer enclosure is in an erected configuration and said outer cavity has increased in size so as to accommodate said popped kernels released from said inner cavity.

31. A container for use in making popcorn in a microwave oven, said container comprising:
a) a self erecting outer enclosure having an internal cavity, said outer enclosure being movable from a first configuration to a second erected configuration, whereby the volume of said internal cavity is increased in said second erected configuration;
b) an inner enclosure containing a plurality of un-popped popcorn kernels and said inner enclosure being located within said expandable internal cavity, said pouch inner enclosure being arranged for releasing popping kernels into said internal cavity, when said container is subjected to a source of heat.

32. A container as claimed in claim 31 wherein said inner enclosure also has a charge associated with said kernels.

33. A container as claimed in claim 32 further comprising a susceptor adapted to absorb heat energy from said heat source to heat said kernels.

34. A container as claimed in claim 33 wherein said source of heat is microwave radiation.

35. A container as claimed in claim 34 wherein said outer enclosure is made from a microwave transparent material.

36. A container as claimed in claim 35 wherein said susceptor is positioned in said internal cavity of said outer enclosure.

37. A container as claimed in claim 36 wherein said susceptor is formed as part of said inner enclosure.

38. A container as claimed in claim in claim 37 wherein said microwave transparent material is cardboard.

39. A container as claimed in claim 31 wherein said first configuration is a generally flattened configuration.

40. A container as claimed in claim 35 wherein said first configuration is a generally flattened configuration.

41. A container as claimed in claim 37 wherein said pouch is made at least in part from a layer of a polyester material.

42. A container as claimed in claim 41 wherein said polyester material is PET.

43. A container as claimed in claim 41 wherein said polyester has a metallic susceptor material deposited on a surface thereof.

44. A container as claimed in claim 37 wherein said susceptor is positioned in said internal cavity adjacent a base panel of said outer enclosure.

45. A container as claimed in claim 38 wherein said cardboard is coated on at least one side with a grease resistant coating.

46. A container as claimed in claim 35 wherein said inner enclosure is constructed to be generally flexible.

47. A container as claimed in claim 46 wherein said inner enclosure is made with an opening formed between two parts of said inner enclosure, said opening being sealed with a heat activated adhesive before said inner enclosure is subjected to heating by microwave radiation, such that when said container is subjected to microwave radiation, said heat activated adhesive will soften to release said seal and allow said opening to open.

48. A container as claimed in claim 45 wherein said inner enclosure is formed with a generally rectangular or square configuration and is sealed with heat activated adhesive on three sides thereof, such that when said container is subjected to microwave radiation, an opening is formed on three sides of said pouch to release said popcorn into said internal cavity.

49. A container as claimed in claim 44 wherein said outer enclosure has a base and said inner enclosure is affixed to said base.

50. A container as claimed in claim 32 wherein said outer enclosure has a square or rectangular base and side walls surrounding and extending up from said base, and wherein said inner enclosure is affixed to said base at a bottom panel, and wherein said bottom panel has a trough to inhibit seepage of any part of the charge out of said cavity.

51. A container as claimed in claim 50 wherein said bottom panel has upwardly directed portions mating with upwardly directed portions of a mating top panel, said upwardly directed portions forming tab portions around a periphery of said inner enclosure, said upwardly directed portions of said bottom panel at least partially defining said trough.

52. A container as claimed in claim 32 wherein said outer enclosure has a square or rectangular base with four corners, and a side wall surrounding and extending up from said base, and wherein said inner enclosure is affixed to said base at a bottom panel, and said base has a barrier at, at least some of said corners to provide a trough so as inhibit the passage of grease or the like from the internal cavity.

53. A container as claimed in claim 32 wherein said outer enclosure is adapted so that said container is self-supporting when said outer enclosure is in said erected configuration.

54. A container as claimed in claim 32 where said outer enclosure comprises:
a) a top panel, a rear wall panel, a base panel and a front wall panel, each of said top, rear, base and front panels, being interconnected at transverse fold lines, in series, along at least one transverse edge and each of said top, rear, base and front panels having a first side edge and a second opposite side edge, each of said first side edges of said top, rear base and front panel being in general longitudinal alignment with each other, and each of said second side edges of said top, rear base and front panel being in general longitudinal alignment with each other;
b) a plurality of side wall panels, each of said top, rear, base and front panels having a side wall panel interconnected at longitudinal fold lines along each of said first and second side edges;
said side panels of said top, rear, base and front panels, co-operating to provide an outer enclosure adapted for movement between said first and second configurations.

55. A container as claimed in claim 54 wherein said side panels connected to said top panel have a tab portion and a notch, and wherein said side panels connected to said bottom panel have a tab portion and a notch, on each side of said top and bottom panel, said tab portions of said related side panels of one of said top and bottom panels, interconnecting with said notch portions of said other of said top and bottom panels, to provide an interlocking of side panels to define side walls of said container.

56. A container as claimed in claim 54 wherein side panels interconnected along said first side edge have features which interlock when said container is moved to said second configuration relationship for assisting in maintaining said outer enclosure in said second configuration.

57. A container as claimed in claim 54 wherein said top panel has one or more score lines defining the outline of an at least partially removable lid portion of said container.

58. A container as claimed in claim 54 wherein said top panel has a tab extension for holding said container.

59. A container as claimed in claim 58 wherein said front panel has a slot for receiving said tab extension to thereby temporary close said lid portion.

60. A method of forming a container for use in making popcorn in a microwave oven, said container comprising an outer enclosure made from a blank and enclosing therein a cavity, said cavity having therein an inner enclosure, said container having a susceptor and said container being adapted to be movable with said susceptor and said inner enclosure enclosed therein from a first configuration to a second erected configuration thereby increasing the volume of said cavity, said method comprising:
a) moving a blank to a pouch placement station, said blank having a plurality of panels, including a base panel;
b) at said pouch placement station, placing a releasable pouch containing a plurality of un-popped popcorn kernels and a charge, on said base panel;
c) folding and securing said panels to enclose said pouch within said cavity formed within said blank, to form a container capable of being moved from said first configuration to said second configuration.

61. A method as claimed in claim 60 wherein said pouch has an associated charge for said popcorn kernels.

62. An apparatus for forming a container for use in making popcorn in a microwave oven, said container comprising an outer enclosure made from a blank and enclosing therein a cavity, said cavity having therein a pouch, said container having a susceptor and said container being adapted to be movable with said susceptor and said inner enclosure enclosed therein from a first configuration to a second erected configuration thereby increasing the volume of said cavity, said apparatus comprising:
a) A magazine holding a plurality of blanks, each of said blanks having a plurality of panels, including a base panel;
b) A conveyor system for moving a blank from said blank magazine to a pouch placement station, and from said pouch placement station to folding and securing stations,
c) A pouch feeder positioned at said pouch placement station for placing a pouch containing a plurality of un-popped popcorn kernels on one of said base panel;
d) A folding and securing station operable to fold said panels to enclose said pouch within said cavity formed within said blank, so as to form a container capable of being moved from said first configuration to said second configuration.

63. A container for use in heating food products comprising:
a) an outer enclosure enclosing a cavity, said outer enclosure made from a rigid or semi-rigid microwave transparent material, said enclosure being formed from a plurality of interconnected panels, said plurality of panels including a plurality of medial panels including a base panel, and a plurality of upstanding side wall panels;
b) a gap between a first side wall panel and a second side wall panel of said plurality of side wall panels, said first and second side wall panels being positioned adjacent to each other and each interconnected to a medial panel,
c) a barrier positioned across said gap and extending between said first side wall panel and said second side wall panel and said base panel, said adapted to block said gap in the vicinity of said base panel to substantially prevent seepage through said gap of fluid held in said cavity.

64. A container as claimed in claim 63 further comprising:
a) an inner pouch containing a plurality of un-popped popcorn kernels and an associated charge and said pouch being located on said base panel and within said cavity, said pouch having an opening activated when said popcorn kernels are subjected to microwave radiation;
b) a susceptor for absorbing microwave radiation to heat said kernels,
wherein at least some of said plurality of kernels will pop and be released by said pouch within said expandable cavity, when said container is subjected to microwave radiation, and wherein said barrier inhibits the seepage of a part of said charge through said gap.

65. A container as claimed in claim 63 wherein said container is configured in the shape of a generally rectangular or square box having a top panel disposed opposite said base panel, and having first, second, third and fourth upstanding side wall panels disposed between said top panel and said base panel, said container having four corners at the abutment of the base plate and respectively, first and second, second and third, third and fourth and fourth and first side walls, with gaps being provided at the said four corners, said barrier located at said front corners to block said four gaps proximate said base, said barrier in abutment with said base, each said barrier being adapted to block said gap in the vicinity of said base panel to substantially prevent seepage through each said gap of fluid held in said cavity.
